(19) United States
(12) Patent Application Publication
(10) Pub. No.: US 2025/0220533 A1
(43) Pub. Date: Jul. 3, 2025

(54) METHOD AND APPARATUS FOR POPULATING ALTERNATIVE PGW-C/SMF INFORMATION

(71) Applicant: Telefonaktiebolaget LM Ericsson (publ), Stockholm (SE)

(72) Inventors: Yunjie LU, Shanghai (CN); Yong YANG, Kållered (SE); Chunbo WANG, Shanghai (CN)

(21) Appl. No.: 18/848,431

(22) PCT Filed: May 12, 2023
(86) PCT No.: PCT/CN2023/093830

§ 371 Date: Sep. 18, 2024

(30) Foreign Application Priority Data
May 12, 2022 (WO) PCT/CN2022/092538

(51) Int. Cl. H04W 36/12; H04W 48/08

(52) U.S. Cl. CPC H04W 36/12; H04W 48/08

(57) ABSTRACT

Embodiments of the present disclosure provide method and apparatus for populating alternative PGW-C/SMF information. A performed by an access and mobility management function (AMF) in a first telecommunication system may include receiving alternative packet data network gateway control plane/Session Management Function (PGW-C/SMF) information from a first PGW-C/SMF or a second SMF. The method may further include sending the alternative PGW-C/SMF information to a mobility management entity, MME in a second telecommunication system.

### TECHNICAL FIELD

The non-limiting and exemplary embodiments of the present disclosure generally relate to the technical field of communications, and specifically to methods and apparatuses for populating alternative Packet Data Network (PDN) gateway (PGW) control plane (PGW-C)/session management function (SMF) information.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example NR (new radio) or long term evolution (LTE) as defined by 3rd Generation Partnership Project (3GPP), it has introduced network function (NF) set based session resilience that the equivalent control plane NFs can be grouped into NF Sets. For example, several PGW control plane (PGW-C)/SMF instances may be grouped into an PGW-C/SMF Set. NFs within a NF Set are interchangeable because they share the same context data. A NF can be replaced by an alternative NF within the same NF set in the case of scenarios such as failure, load balancing, load re-balancing, etc. A SMF can act as anchor SMF, intermediate SMF (I-SMF), visited SMF (V-SMF), or home SMF (H-SMF) roles for different protocol data unit (PDU) session contexts.

In 3GPP Release 17, it has introduced the support of combined PGW-C/SMF set to enable to restore PDN Connections or PDU Sessions affected (by a combined PGW-C/SMF failure) by (re) selecting an alternative (combined) PGW-C/SMF which pertains to the same NF set, so that, the PDN connectivity (offered by the PDN connection) towards the Packet Data Network (e.g. for application service) can be maintained.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As specified by 3GPP TS 23.007 V17.4.1, the disclosure of which is incorporated by reference herein in its entirety, the alternative PGW-C/SMF information (i.e. PGW Change Info IE (information element)) is only provided to a mobility management entity (MME) or an evolved packet data gateway (ePDG) by the PGW-C/SMF when a user equipment (UE) is camping in a fourth generation (4G) network. In addition, during PDN connection establishment (see clause 31.2A of 3GPP TS 23.007 V17.4.1), such alternative PGW-C/SMF information can also be populated from a source MME to a target MME during a mobility procedure (See clause 31.5 below of 3GPP TS 23.007 V17.4.1).

However, when UE moves from 5GS to EPS (e.g., 3gpp access or non-3gpp access), when the MME or ePDG attempts to contact the combined PGW-C/SMF, and if the PGW-C/SMF is not reachable, even when the combined PGW-C/SMF set is deployed, since the MME or ePDG is lack of the alternative PGW information, the PDN connection cannot be moved to EPS and PDN connectivity is broken which it should not.

The issue is getting worse when it is a home routed PDU session with a V-SMF involved, or a PDU session with Intermediate-SMF where at preparation phase of 5G to 4G mobility procedure, the PGW-C/SMF was not involved.

MME/SGSN (Serving GPRS (General Packet Radio Service) Support Node)/AMF UE Evolved Packet System (EPS) PDN Connections included in the Forward Relocation Request message and Context Response message (will be sent from the AMF to MME during mobility from 5G to 4G), are prepared by the V/I-SMF (for a Home Routed PDU session with a V-SMF involved, or a PDU session with Intermediate-SMF).

When Anchor SMF is reselected, the corresponding information in the EPS PDN Connection Context information will most likely be updated. For example, the Internet protocol (IP) address of the S8-c F-TEID (fully TEID (qualified terminal endpoint identifier)) may include the IP of the new anchor SMF. The pgwNodeName of the different SMFs most likely are different.

Currently there is no way for the new anchor SMF to inform the V-SMF/I-SMF of the updated EPS PDN Connection Context. If 5GS (fifth generation system) to EPS mobility happen, the AMF will retrieve the context from the I-SMF/V-SMF based on the old information. With the old information, the PDU session cannot be moved to EPS because MME/SGW (serving gateway) will find the wrong PGW-C/SMF in EPS.

To overcome or mitigate at least one of above mentioned problems or other problems, a solution for populating alternative PGW-C/SMF information is needed.

In a first aspect of the disclosure, there is provided a method performed by an access and mobility management function (AMF) in a first telecommunication system. The method may comprise receiving alternative packet data network gateway control plane/Session Management Function (PGW-C/SMF) information from a first PGW-C/SMF or a second SMF. The method may further comprise sending the alternative PGW-C/SMF information to a mobility management entity, MME in a second telecommunication system.

In an embodiment, receiving the alternative PGW-C/SMF information from the first PGW-C/SMF or the second SMF may comprise sending a Protocol Data Unit (PDU) session context request to the first PGW-C/SMF or the second SMF and receiving a PDU session context response comprising the alternative PGW-C/SMF information from the first PGW-C/SMF or the second SMF.

In an embodiment, sending the alternative PGW-C/SMF information to the MME may comprises receiving a context request from the MME and sending a context response comprising the alternative PGW-C/SMF information to the MME.

In an embodiment, the first PGW-C/SMF may be a home PGW-C/SMF or an anchor PGW-C/SMF and/or the second SMF may be a visited SMF or an intermediate SMF.

In an embodiment, the alternative PGW-C/SMF information may comprise information of at least one PGW-C/SMF, so that an alternative PGW-C/SMF can be selected.

In an embodiment, the alternative PGW-C/SMF information may be used by the AMF or the MME or an evolved packet data gateway (ePDG) to select an alternative PGW-C/SMF.

In an embodiment, the first PGW-C/SMF and the alternative PGW-C/SMF may be functionally equivalent and inter-changeable and share same contexts.

In a second aspect of the disclosure, there is provided a method performed by a first PGW-C/SMF. The method may comprise establishing a PDU session for a User Equipment (UE). The method may further comprise sending alternative PGW-C/SMF information to a second SMF for the PDU session anchored at the first SMF+PGW-C or an access and mobility management function (AMF). An alternative PGW-C/SMF will be selected based on the alternative PGW-C/SMF information in an event the first PGW-C/SMF has failed.

In an embodiment, sending the alternative PGW-C/SMF information to the second SMF may comprise receiving a protocol data unit (PDU) session create request from the second SMF. The method may further comprise sending a PDU session create response comprising the alternative PGW-C/SMF information to the second SMF.

In an embodiment, the alternative PGW-C/SMF information may be comprised in PDU session created data of the PDU session create response.

In an embodiment, the first PGW-C/SMF may be a home PGW-C/SMF or an anchor PGW-C/SMF and/or the second SMF may be a visited SMF or an intermediate SMF.

In an embodiment, sending the alternative PGW-C/SMF information to the second SMF may comprise receiving a PDU session update request from the second SMF and sending a PDU session update response comprising the alternative PGW-C/SMF information to the second SMF.

In an embodiment, the alternative PGW-C/SMF information may be comprised in home SMF updated data of the PDU session update response.

In an embodiment, the first PGW-C/SMF may be a home PGW-C/SMF or an anchor PGW-C/SMF and/or the second SMF may be a new visited SMF or a new intermediate SMF.

In an embodiment, sending the alternative PGW-C/SMF information to the second SMF may comprise sending a PDU session update request comprising the alternative PGW-C/SMF information to the second SMF and receiving a PDU session update response from the second SMF.

In an embodiment, the alternative PGW-C/SMF information may be comprised in visited SMF update data of the PDU session update request.

In an embodiment, the first PGW-C/SMF may be a home PGW-C/SMF or an anchor PGW-C/SMF and/or the second SMF may be a visited SMF or an intermediate SMF.

In an embodiment, sending the alternative PGW-C/SMF information to the AMF may comprise receiving a PDU session context request from the AMF and sending a PDU session context response comprising the alternative PGW-C/SMF information to the AMF.

In an embodiment, the alternative PGW-C/SMF information may comprise information of at least one PGW-C/SMF, so that the alternative PGW-C/SMF can be selected.

In an embodiment, the alternative PGW-C/SMF information may be used by the AMF or a mobility management entity (MME) or an evolved packet data gateway (ePDG) to select an alternative PGW-C/SMF.

In an embodiment, the first PGW-C/SMF and the alternative PGW-C/SMF may be functionally equivalent and inter-changeable and share same contexts.

In a third aspect of the disclosure, there is provided method performed by a mobility management entity (MME). The method may comprise sending a context request to an access and mobility management function (AMF). The method may further comprise receiving a context response comprising first session management function (SMF) information and alternative packet data network gateway (PGW) control plane (PGW-C)/SMF information from the AMF.

In an embodiment, the method may further comprise determining that the first PGW-C/SMF is failed. The method may further comprise selecting an alternative PGW-C/SMF based on the alternative PGW-C/SMF information. The method may further comprise sending a create session request to the alternative PGW-C/SMF.

In an embodiment, the first PGW-C/SMF may be a home PGW-C/SMF or an anchor PGW-C/SMF.

In an embodiment, the first PGW-C/SMF and the alternative PGW-C/SMF may be functionally equivalent and inter-changeable and share same contexts.

In an embodiment, the alternative PGW-C/SMF information may comprise information of at least one PGW-C/SMF, so that the alternative PGW-C/SMF can be selected.

In a fourth aspect of the disclosure, there is provided an access and mobility management function (AMF). The AMF comprises a processor and a memory coupled to the processor. Said memory contains instructions executable by said processor. The AMF is operative to receive alternative packet data network gateway control plane/Session Management Function (PGW-C/SMF) information from a first PGW-C/SMF or a second SMF. The AMF is further operative to send the alternative PGW-C/SMF information to a mobility management entity, MME in a second telecommunication system.

In a fifth aspect of the disclosure, there is provided a first PGW-C/SMF. The first PGW-C/SMF comprises a processor and a memory coupled to the processor. Said memory contains instructions executable by said processor. The first PGW-C/SMF is operative to establish a PDU session for a User Equipment (UE). The first PGW-C/SMF is further operative to send alternative PGW-C/SMF information to a second SMF for the PDU session anchored at the first SMF+PGW-C or an access and mobility management function (AMF). An alternative PGW-C/SMF will be selected based on the alternative PGW-C/SMF information in an event the first PGW-C/SMF has failed.

In a sixth aspect of the disclosure, there is provided a mobility management entity (MME). The MME comprises a processor and a memory coupled to the processor. Said memory contains instructions executable by said processor. The MME is operative to send a context request to an access and mobility management function (AMF). The MME is further operative to receive a context response comprising first PGW-C/SMF information and alternative packet data network gateway (PGW) control plane (PGW-C)/SMF information from the AMF.

In a seventh aspect of the disclosure, there is provided a first PGW-C/SMF. The first PGW-C/SMF may comprise an establishing module configured to establish a PDU session for a User Equipment (UE). The first PGW-C/SMF may further comprise a sending module configured to send alternative PGW-C/SMF information to a second SMF for the PDU session anchored at the first SMF+PGW-C or an access and mobility management function (AMF). An alternative PGW-C/SMF will be selected based on the alternative PGW-C/SMF information in an event the first PGW-C/SMF has failed.

In an eighth aspect of the disclosure, there is provided an AMF in a first telecommunication system. The AMF may comprise a receiving module configured to receive alternative packet data network gateway control plane/Session Management Function (PGW-C/SMF) information from a first PGW-C/SMF or a second SMF. The AMF may comprise a sending module configured to send the alternative PGW-C/SMF information to a mobility management entity (MME) in a second telecommunication system.

In a ninth aspect of the disclosure, there is provided an MME according to an embodiment of the disclosure. As shown, the MME may comprise a first sending module configured to send a context request to an access and mobility management function (AMF). The MME may further comprise a receiving module configured to receive a context response comprising first PGW-C/SMF information and alternative packet data network gateway (PGW) control plane (PGW-C)/SMF information from the AMF.

In an embodiment, the MME may further comprise a determining module configured to determine that the first SMF is failed.

In an embodiment, the MME may further comprise a selecting module configured to select an alternative PGW-C/SMF based on the alternative PGW-C/SMF information.

In an embodiment, the MME may further comprise a second sending module configured to send a create session request to the alternative PGW-C/SMF.

In another aspect of the disclosure, there is provided a computer program product comprising instructions which when executed by at least one processor, cause the at least one processor to perform the method according to any one of the first to third aspects.

In another aspect of the disclosure, there is provided a computer-readable storage medium storing instructions which when executed by at least one processor, cause the at least one processor to perform the method according to any one of the first to third aspects.

Embodiments herein may provide many advantages, of which a non-exhaustive list of examples follows. In some embodiments herein, it can secure that the PDU session can successfully move from 5G to 4G mobility even when the serving combined PGW-C/SMF has failed (as long as it pertains to a combined PGW-C/SMF set). In some embodiments herein, it can enable the MME or ePDG or AMF to select an alternative PGW-C/SMF based on the alternative PGW-C/SMF information. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a flowchart of handover procedure from 5GS to EPS when N26 is supported;

FIG. 1b shows a flowchart of 5GS to EPS Idle mode mobility using N26 interface;

FIG. 1c shows a flowchart of handover from 5GS to EPC/ePDG;

FIG. 1d shows a flowchart of Handover from 3GPP Access to Untrusted Non-3GPP IP Access with GTP on S2b;

FIG. 1e shows a flowchart of Handover from 3GPP Access to Untrusted Non-3GPP IP Access with PMIPv6 on S2b;

FIG. 1f shows a flowchart of PDN connection establishment;

FIG. 2a schematically shows non-roaming architecture for interworking between 5GS and EPC/E-UTRAN;

FIG. 2b schematically shows home-routed roaming architecture for interworking between 5GS and EPC/E-UTRAN;

FIG. 2c schematically shows home-routed roaming architecture for interworking between ePDG/EPC and 5GS;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 3d shows a flowchart of a method according to another embodiment of the present disclosure;

FIG. 3e shows a flowchart of a method according to another embodiment of the present disclosure;

FIG. 3f shows a flowchart of a method according to another embodiment of the present disclosure;

FIG. 3g shows a flowchart of SMF registration according to an embodiment of the present disclosure;

FIG. 3h shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 4d shows a flowchart of a method according to another embodiment of the present disclosure;

FIG. 4e shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 5c shows a flowchart of a method according to another embodiment of the present disclosure;

FIG. 5d shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 7a shows a flowchart of a method according to another embodiment of the present disclosure;

FIG. 7b shows a flowchart of a method according to another embodiment of the present disclosure;

FIG. 8a shows a flowchart of a method according to another embodiment of the present disclosure;

FIG. 8b shows a flowchart of a method according to another embodiment of the present disclosure;

FIG. 9 shows a flowchart of how PGW Change Info is to be added in various signaling messages according to another embodiment of the present disclosure;

FIG. 10 is a block diagram showing an apparatus suitable for practicing some embodiments of the disclosure;

FIG. 11a is a block diagram showing a first SMF according to an embodiment of the disclosure;

FIG. 11b is a block diagram showing a first PGW-C/SMF according to an embodiment of the disclosure;

FIG. 12 is a block diagram showing a second SMF according to an embodiment of the disclosure;

FIG. 13a is a block diagram showing an AMF according to an embodiment of the disclosure;

FIG. 13b is a block diagram showing an AMF in a first telecommunication system according to an embodiment of the disclosure;

FIG. 14 is a block diagram showing an MME according to an embodiment of the disclosure;

FIG. 15 is a block diagram showing a UDM according to an embodiment of the disclosure; and

FIG. 16 is a block diagram showing an ePDG according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (access and mobility management function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), PGW user plane (PGW-U), Serving gateway (SGW), SGW control plane (SGW-C), E-UTRAN (Evolved Universal Terrestrial Radio Access Network) Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP’ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

Clause 31 of 3GPP TS 23.007 V17.4.1 describes restoration of PDN connections after a PGW-C/SMF change as below.

The procedure specified in clause 31 of 3GPP TS 23.007 V17.4.1 enables to restore in the EPC (Evolved Packet Core) the PDN connections affected by an PGW-C/SMF failure with or without restart or scale-in operation, and thus to maintain the UE connectivity to the PDN and corresponding services with minimum service interruption and minimal signaling in the network (e.g. no signaling with the UE).

The procedure specified in clause 31 of 3GPP TS 23.007 V17.4.1 is optional to support for the MME, ePDG supporting S2b over GTPv2, SGW and PGW-C/SMF.

The procedure specified in clause 31 of 3GPP TS 23.007 V17.4.1 applies for combo PGW-C/SMF that is deployed in an PGW-C/SMF set (i.e. a set of PGW-C/SMF instances that are functionally equivalent and inter-changeable and that share the same contexts, see clause 5.21.3 of 3GPP TS 23.501 V17.2.0, the disclosure of which is incorporated by reference herein in its entirety).

In scenarios where a PGW-C/SMF becomes no longer available (e.g. PGW-C/SMF failure without restart, scale-in operation causing a PGW-C/SMF to be de-instantiated from the PGW-C/SMF set) or that require to change the PGW-C/SMF of a PDN connection, other PGW-C/SMFs from the same PGW-C/SMF set may take over the control of the PDN connections that were served by the PGW-C/SMF that is no longer available. When a PGW-C/SMF fails with restart, the restarted PGW-C/SMF should continue supporting the same PDN connections, if possible. When a PGW-C/SMF of a PGW-C/SMF set fails with or without restart, the recovery (Restart Counter) shall not be incremented over S5/S8 (assuming the PDN connection context is still available in the PGW-C/SMF set).

The restoration of a PDN connection may be triggered by the MME (e.g. when the SGW detects and reports to the MME that the PGW-C has failed) or by the ePDG supporting S2b over GTPv2, or by the PGW-C/SMF (e.g. scale-in operation or PGW-C/SMF reselection by another network function such as PCF).

The procedure specified in clause 31 of 3GPP TS 23.007 V17.4.1 supports the restoration of Home Routed PDN connections, if the VPLMN (Visited PLMN (Public Land Mobile Network)) and HPLMN (home PLMN) support this procedure. If the VPLMN or HPLMN does not support this procedure, the existing behavior applies, e.g. the MME and SGW clears all PDN connections of the PGW-C/SMF when detecting the failure or restart of the PGW-C/SMF and the MME may request UEs to release and reactivate some PDN connections (e.g. IMS (IP Multimedia Subsystem) PDN connections).

Mobility from 5G to 4G (include 3GPP access and non-3GPP access) are supported as specified in clause 4.11 of 3GPP TS 23.502 V17.2.1 as below, the disclosure of which is incorporated by reference herein in its entirety.

### 5GS to EPS Handover Using N26 Interface

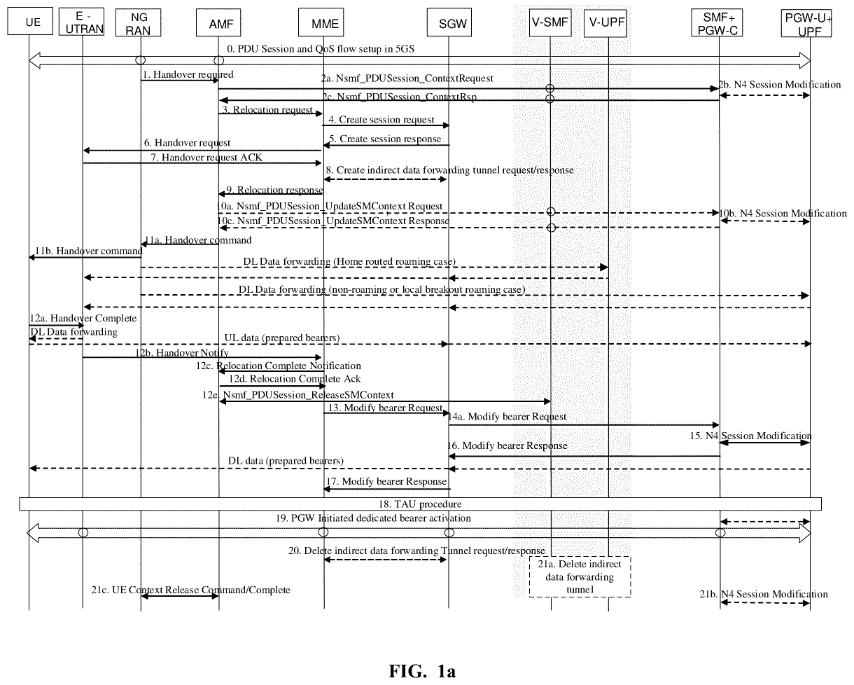

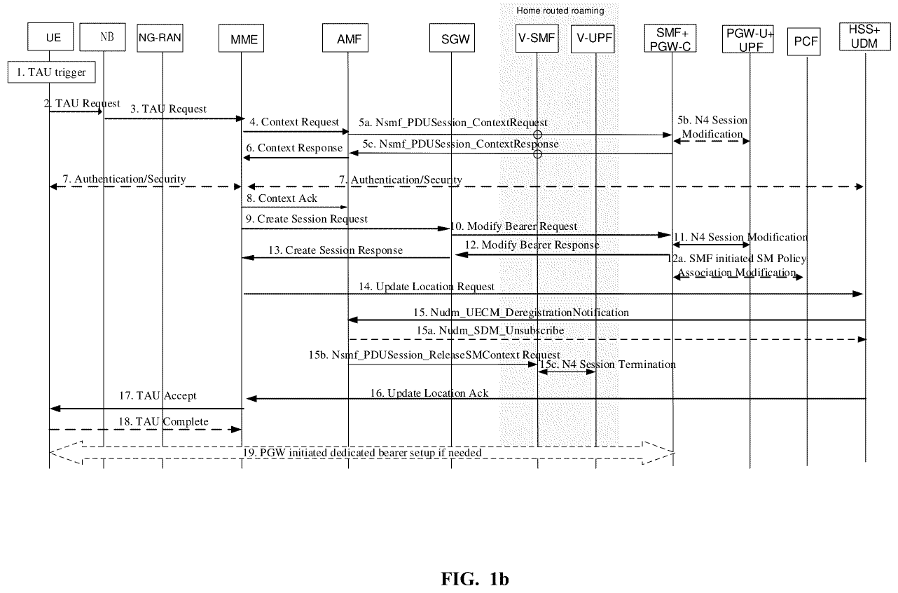

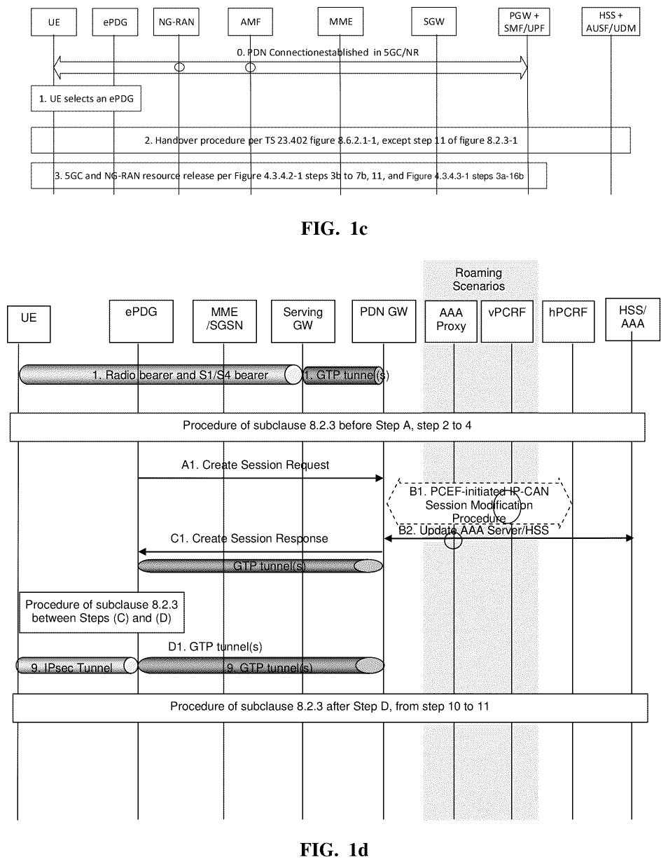

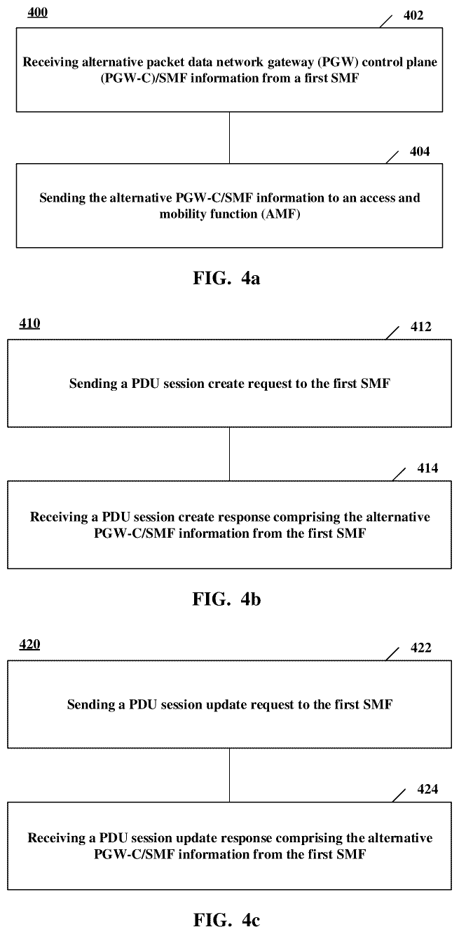

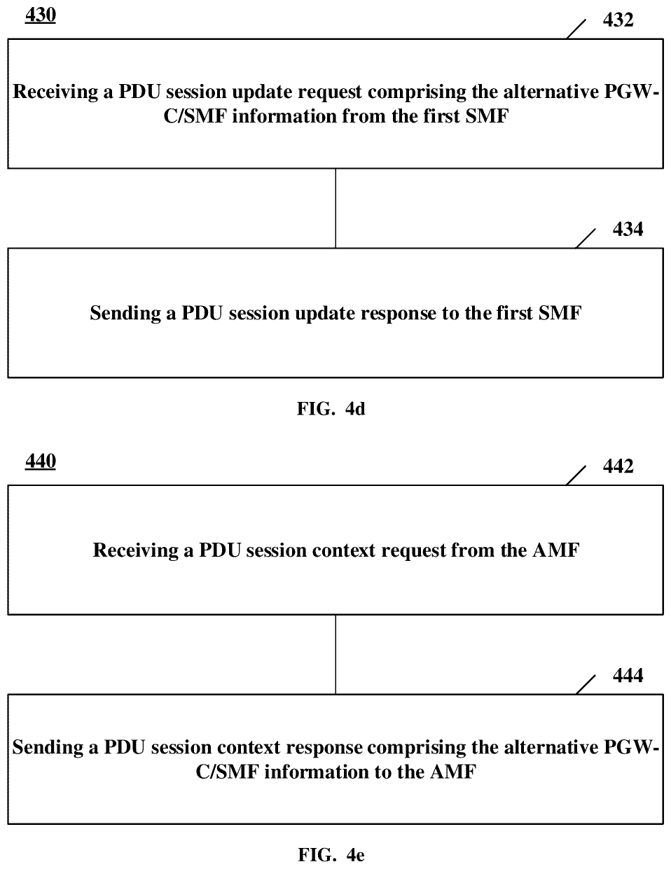

FIG. 1a shows a flowchart of handover procedure from 5GS to EPS when N26 is supported, which is same as FIG. 4.11.1.2.1-1 of 3GPP TS 23.502 V17.2.1.

In the case of handover to a shared EPS network, the source NG-RAN (next generation RAN) determines a PLMN to be used in the target network as specified by 3GPP TS 23.501 V17.2.0. The source NG-RAN shall indicate the selected PLMN ID (identifier) to be used in the target network to the AMF as part of the TAI (tracking area identity) sent in the HO (Handover) Required message.

In the case of handover from a shared NG-RAN, the AMF may provide the MME with an indication that the 5GS PLMN is a preferred PLMN at later change of the UE to a 5GS shared networks.

During the handover procedure, as specified in clause 4.9.1.3.1 of 3GPP TS 23.502 V17.2.1, the source AMF shall reject any SMF+PGW-C initiated N2 request received since handover procedure started and shall include an indication that the request has been temporarily rejected due to handover procedure in progress.

Upon reception of a rejection for an SMF+PGW-C initiated N2 request (s) with an indication that the request has been temporarily rejected due to handover procedure in progress, the SMF+PGW-C behaves as specified in 3GPP TS 23.401 V17.3.0, the disclosure of which is incorporated by reference herein in its entirety.

At step 2a-2c. The AMF determines from the “Target eNB Identifier’ IE that the type of handover is Handover to E-UTRAN. The AMF selects an MME as described in clause 4.3.8.3 of 3GPP TS 23.401 V17.3.0.

The AMF determines for a PDU Session whether to retrieve context including mapped UE EPS PDN Connection from the V-SMF (in the case of HR (Home Routed) roaming) or the SMF+PGW-C (in the case of non roaming or LBO (Local Break Out) roaming) as follows:
If the AMF determines that one or more of the EBI (EPS Bearer Identity) (s) can be transferred, the AMF sends Nsmf_PDUSession_ContextRequest to the V-SMF or SMF+PGW-C and includes in the message EBI value (s) if any that cannot be transferred.
The EBI values (s) that cannot be transferred is determined by the AMF if the target MME does not support 15 EPS bearers, i.e. the AMF determines the EBI values in range 1-4 as not to be transferred to EPS, and if there are still more than 8 EBI values associated with PDU Sessions, the AMF then determines EBI value (s) not to be transferred to EPS based on S-NSSAI and ARP as specified in clause 5.17.2.2.1 of 3GPP TS 23.501 V17.2.0.
The AMF does not retrieve the context for a PDU Session that cannot be transferred to EPS due to no EBI allocated, or allocated EBIs not transferrable, or combination of the two.

The other steps are described in clause 4.11.1.2.1 of 3GPP TS 23.502 V17.2.1, the description thereof is omitted here for brevity.

### 5GS to EPS Idle Mode Mobility Using N26 Interface

FIG. 1b shows a flowchart of 5GS to EPS Idle mode mobility using N26 interface, which is same as FIG. 4.11.1.3.2-1 of 3GPP TS 23.502 V17.2.1.

In the case of network sharing the UE selects the target PLMN ID according to clause 5.18.3 of 3GPP TS 23.501 V17.2.0.

Clause 4.11.1.3.2 of 3GPP TS 23.502 V17.2.1 covers the case of idle mode mobility from 5GC (5G core) to EPC. UE performs Tracking Area Update procedure in E-UTRA (Evolved Universal Terrestrial Radio Access)/EPS when it moves from NG-RAN/5GS to E-UTRA/EPS coverage area.

The procedure as specified in clause 4.11.1.3.2 of 3GPP TS 23.502 V17.2.1 involves a Tracking Area Update to EPC and setup of default EPS bearer and dedicated bearers in EPC in steps 1-11 and re-activation, if required.

At step 5a. The AMF verifies the integrity of the TAU request message:

The AMF determines for a PDU Session whether to retrieve context including mapped UE EPS connection from V-SMF (in the case of HR roaming) or from the SMF+PGW-C (in the case of non roaming or LBO roaming) as follows:
If the AMF determines that one or more of the EBI (s) can be transferred, the AMF sends Nsmf_PDUSession_ContextRequest to the V-SMF or SMF+PGW-C and includes in the message EBI value (s) if any that cannot be transferred.
The EBI values (s) that cannot be transferred is determined by the AMF if the target MME does not support 15 EPS bearers, i.e. the AMF determines the EBI values in range 1-4 as not to be transferred to EPS, and if there are still more than 8 EBI values associated with PDU Sessions, the AMF then determines EBI value (s) not to be transferred to EPS based on S-NSSAI and ARP as specified in clause 5.17.2.2.1 of 3GPP TS 23.501 V17.2.0.
The AMF does not retrieve the context for a PDU Session that cannot be transferred to EPS due to no EBI allocated, or allocated EBIs not transferrable, or combination of the two.

In non-roaming or LBO roaming, the AMF retrieves context that includes the mapped EPS Bearer Contexts.
The AMF provides in Nsmf_PDUSession_ContextRequest the target MME capability to the PGW C+SMF in the request to allow the SMF+PGW-C to determine whether to include EPS Bearer context for Ethernet PDN type or non-IP PDN Type or not.
If the AMF includes in Nsmf_PDUSession_ContextRequest EBI list not to be transferred, and if the EBI value of the QoS Flow associated with the default QoS Rule is included in that list, the SMF+PGW-C shall not return the PDN Connection context (which implies the whole PDU Session is not transferred to EPS), otherwise if the EBI value of the QoS Flow associated with the default QoS Rule is not included in the EBI list not to be transferred, the V-SMF or SMF+PGW-C shall not provide the EPS bearer context (s) mapped from QoS Flow (s) associated with that list.
When the AMF sends Nsmf_PDUSession_ContextRequest to the V-SMF or the SMF+PGW-C, the AMF indicates whether the target MME supports User Plane Integrity Protection with EPS.

The above steps are performed with all the SMF+PGW-Cs corresponding to PDU Sessions of the UE which are associated with 3GPP access and have EBI (s) allocated to them.

In Home Routed roaming, the AMF requests the V-SMF to provide SMF Context by using Nsmf_PDUSession_ContextRequest.

NOTE 1: The AMF knows the MME capability to support 15 EPS bearers, support User Plane Integrity Protection with EPS, Ethernet PDN Type and/or non-IP PDN type or not through local configuration

The other steps are described in Clause 4.11.1.3.2 of 3GPP TS 23.502 V17.2.1, the description thereof is omitted here for brevity.

Handover from 5GS to EPC/ePDG

FIG. 1c shows a flowchart of handover from 5GS to EPC/ePDG, which is same as FIG. 4.11.4.2-1 of 3GPP TS 23.502 V17.2.1.

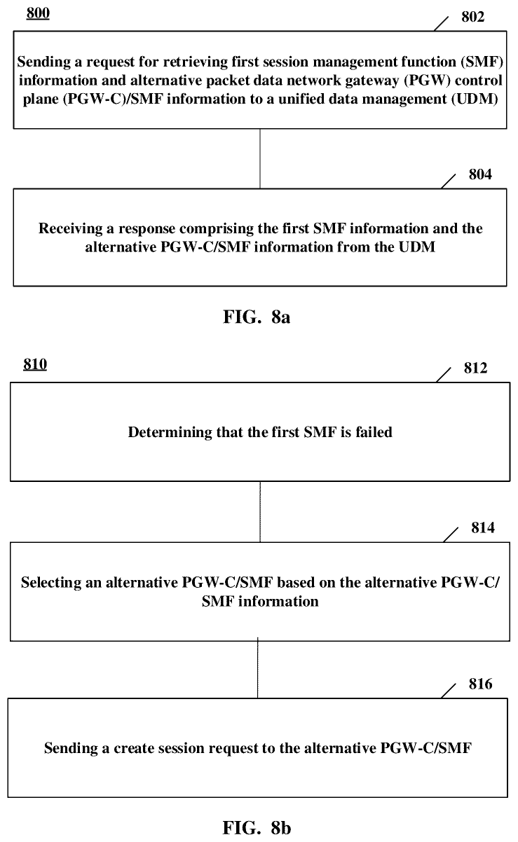

At step 2. The UE initiates a handover procedure as described in clause 8.6.2.1 of 3GPP TS 23.402 V17.0.0, except step 11 of referenced FIG. 8.2.3-1 of 3GPP TS 23.402 V17.0.0 that corresponds to the release of resources in source system.

The other steps are described in Clause 4.11.4.2 of 3GPP TS 23.502 V17.2.1, the description thereof is omitted here for brevity.

FIG. 1d shows a flowchart of Handover from 3GPP Access to Untrusted Non-3GPP IP Access with GTP on S2b, which is same as FIG. 8.6.2.1-1 of 3GPP TS 23.402 V17.0.0.

Procedure of subclause 8.2.3 of 3GPP TS 23.402 V17.0.0 before Step A, step 2 to 4.

The other steps are described in Clause 8.6.2.1 of 3GPP TS 23.402 V17.0.0, the description thereof is omitted here for brevity.

FIG. 1e shows a flowchart of Handover from 3GPP Access to Untrusted Non-3GPP IP Access with PMIPv6 on S2b, which is same as FIG. 8.2.3-1 of 3GPP TS 23.402 V17.0.0.

At step 4. The IKEv2 tunnel establishment procedure is started by the UE. The ePDG IP address to which the UE needs to form IPsec tunnel with is discovered as specified in clause 4.5.4 of 3GPP TS 23.402 V17.0.0. After the UE is authenticated, UE is also authorized for access to the APN (access point name). As part of access authentication the PDN GW identity is sent to the ePDG by the 3GPP AAA (authentication, authorization and accounting) server.

The other steps are described in Clause 8.2.3 of 3GPP TS 23.402 V17.0.0, the description thereof is omitted here for brevity.

As specified by 3GPP TS 23.007 V17.4.1, the alternative PGW-C/SMF information (i.e. PGW Change Info IE (information element)) is only provided to a mobility management entity (MME) or an evolved packet data gateway (ePDG) by the PGW-C/SMF when a user equipment (UE) is camping in fourth generation (4G) network. For example, during PDN connection establishment (see clause 31.2A of 3GPP TS 23.007 V17.4.1), such alternative PGW-C/SMF information can also populated from a source MME to a target MME during a mobility procedure (See clause 31.5 below of 3GPP TS 23.007 V17.4.1).

FIG. 1f shows a flowchart of PDN connection establishment, which is same as FIG. 31.2A-1 of 3GPP TS 23.007 V17.4.1.

The PDN connection shall be established as defined in clause 7.2.4 of 3GPP TS 23.402 V17.0.0 with the following additions.

At step 1. During the PDN connection establishment or when a PDU session is moved from 5GS to EPC/ePDG, the ePDG may signal in the Create Session Request that it supports this procedure by including a PGW Set Support Indication.

At step 2. If the Create Session Request indicates support of this procedure, the PGW-C/SMF may return a PGW Change Info IE in the Create Session Response. The PGW Change Info IE shall contain the PGW Set FQDN or Alternative PGW-C/SMF FQDN or IP Addresses of PGW/SMFs in the set; receipt of this information indicates to the ePDG that this procedure is supported by PGW-C/SMF for the PDN connection and that alternative PGW-C/SMF instances may be found using the PGW Set FQDN or the Alternative PGW FQDN or IP addresses, if the PGW-C/SMF becomes no longer reachable.

Likewise, a PDU session shall be moved from 5GS to EPC/ePDG as defined in clause 4.11.4 of 3GPP TS 23.502 V17.2.1 with the following additions:
the ePDG may signal that it supports this procedure by including a PGW Set Support Indication in the Create Session Request during handover from 5GS to EPC/ePDG (see clause 4.11.4.2 of 3GPP TS 23.502 V17.2.1); and
If the Create Session Request received by the PGW-C/SMF indicates support of this procedure, the PGW-C/SMF may return a PGW Change Info IE (with the same content as described above) in the Create Session Response to provide the same indication as described above to the ePDG.

Clause 31.5 of 3GPP TS 23.007 V17.4.1 describes Inter-MME mobility. During inter-MME mobility, the source MME shall transfer the PGW Change Info to the target MME, if available.

However, when UE moves from 5GS to EPS (3gpp access or non-3gpp access), when the MME or ePDG attempts to contact the combined PGW-C/SMF, and if the PGW-C/SMF is not reachable, even when the combined PGW-C/SMF set is deployed, since the MME or ePDG are lack of alternative PGW information, the PDN connection can NOT be moved to EPS, PDN connectivity is broken which it should not.

The issue is getting worse when it is a Home Routed PDU session with a V-SMF involved, or a PDU session with Intermediate-SMF where at preparation phase of 5G to 4G mobility procedure, the PGW-C/SMF was not involved.

MME/SGSN (Serving GPRS (General Packet Radio Service) Support Node)/AMF UE EPS PDN Connections included in the Forward Relocation Request message and Context Response message (will be sent from the AMF to MME during mobility from 5G to 4G), are prepared by the V/I-SMF (for a Home Routed PDU session with a V-SMF involved, or a PDU session with Intermediate-SMF).

The following tables are excerpted from 3GPP TS 29.274 V17.5.0, the disclosure of which is incorporated by reference herein in its entirety.

TABLE 7.3.1-2
MME/SGSN/AMF UE EPS PDN Connections
within Forward Relocation Request

| Octet 1 | PDN Connection IE Type = 109 (decimal) | | | |
|---|---|---|---|---|
| Octets 2 | Length = n | | | |
| and 3 | | | | |
| Octet 4 | Spare and Instance fields | | | |
| Information | | | | |
| elements | P | Condition/Comment | IE Type | Ins. |
| APN | M | | APN | 0 |

. . .

| | | | | |
|---|---|---|---|---|
| PGW Change | CO | This IE shall be sent over | PGW | 0 |
| Info | | the S10 interface if | Change | |
| | | available. | Infor | |

. . .

TABLE 7.3.1-8
PGW Change Info with Forward Relocation Request

| Octet 1 | PGW Change Info IE Type = 214 (decimal) | | | |
|---|---|---|---|---|
| Octets | Length = n | | | |
| 2 and 3 | | | | |
| Octet 4 | Spare and Instance fields | | | |
| Information | | | | |
| elements | P | Condition/Comment | IE Type | Ins. |
| PGW Set | CO | This IE shall be included by the | PGW | 0 |
| FQDN | | source MME if available. | FQDN | |
| Alternative | CO | This IE shall be included by the | IP | 0 |
| PGW-C/SMF | | source MME if available. | Address | |
| IP Address | | Several IEs with the same type and instance | | |
| | | value may be included to represent a list of | | |
| | | Alternative PGW-C/SMF IP Addresses. | | |
| Alternative | CO | This IE shall be included by the | PGW | 1 |
| PGW-C/SMF | | source MME if available. | FQDN | |
| FQDN | | Several IEs with the same type and instance | | |
| | | value may be included to represent a list | | |
| | | of Alternative PGW-C/SMF FQDNs. | | |

TABLE 7.3.6-2
MME/SGSN/AMF UE EPS PDN Connections
within Context Response

| Octet 1 | PDN Connection IE Type = 109 (decimal) | | | |
|---|---|---|---|---|
| Octets 2 and 3 | Length = n | | | |
| Octet 4 | Spare and Instance fields | | | |
| Information | | | | |
| elements | P | Condition/Comment | IE Type | Ins. |
| APN | M | | APN | 0 |

. . .

| | | | | |
|---|---|---|---|---|
| PGW | CO | This IE shall be sent over | PGW | 0 |
| Change Info | | the S10 interface if | Change | |
| | | available. | Info | |

. . .

TABLE 7.3.6-6
PGW Change Info with Context Response

| Octet 1 | PGW Change Info IE Type = 214 (decimal) | | | |
|---|---|---|---|---|
| Octets 2 and 3 | Length = n | | | |
| Octet 4 | Spare and Instance fields | | | |
| Information | | | | |
| elements | P | Condition/Comment | IE Type | Ins. |
| PGW Set | CO | This IE shall be included by | PGW | 0 |
| FQDN | | the source MME if available. | FQDN | |
| Alternative | CO | This IE shall be included | IP | 0 |
| PGW-C/SMF | | by the source MME if available. | Address | |
| IP Address | | Several IEs with the same type | | |
| | | and instance value may be included to | | |
| | | represent a list of Alternative | | |
| | | PGW-C/SMF IP Addresses. | | |
| Alternative | CO | This IE shall be included by | PGW | 1 |
| PGW-C/SMF | | the source MME if available. | FQDN | |
| FQDN | | Several IEs with the same type | | |
| | | and instance value may be | | |
| | | included to represent | | |
| | | a list of Alternative | | |
| | | PGW-C/SMF FQDNs. | | |

The data type SmContextRetrievedData as specified in 3GPP TS 29.502 V17.4.0 is the message body of Nsmf_PDUSession_ContextResponse message, see also 4.11.1.2.2, 4.11.1.3.2 of 3GPP TS 29.502 V17.4.0, step 2a, 5a respectively.

The following tables are excerpted from 3GPP TS 29.502 V17.4.0.

TABLE 6.1.6.2.27-1
Definition of type SmContextRetrievedData

| Attribute | | | Cardin- | | Applic- |
|---|---|---|---|---|---|
| name | Data type | P | ality | Description | ability |
| ueEpsPdn- | EpsPdnCnx- | M | 1 | This IE shall contain an MME/SGSN | |
| Connection | Container | | | UE EPS PDN Connection including the mapped | |
| | | | | EPS bearer context(s), if | |
| | | | | the SM context type was not | |
| | | | | present in the request or if it was present and | |
| | | | | indicated a request to retrieve the UE EPS | |
| | | | | PDN Connection. | |
| | | | | This IE shall be set to an empty | |
| | | | | string if the SM context type was present in | |
| | | | | the request and indicated a request to | |
| | | | | retrieve the complete SM context | |
| | | | | or the AF Coordination Information. | |

TABLE 6.1.6.3.2-1
Simple data types

| | | |
|---|---|---|
| FpsPdnCnxContainer | string | String with format “byte” as defined |
| | | in OpenAPI Specification [15], |
| | | i.e. base64-encoded characters, encoding the |
| | | UeEpsPdnConnection IE |
| | | specified in Table 7.3.1-2 or Table 7.3.6-2 |
| | | of 3GPP TS 29.274 [16] for the N26 interface. |

TABLE 6.1.6.3.2-1
Definition of type EpsPdnCnxInfo

| | | | Cardin- | |
|---|---|---|---|---|
| Attribute name | Data type | P | ality | Description |
| pgwS8cFteid | Bytes | M | 1 | Base64-encoded characters, |
| | | | | encoding the PGW S8 F-TEID |
| | | | | for Control Plane as specified |
| | | | | in FIG. 8.22-1 of |
| | | | | 3GPP TS 29.274 [16] |
| | | | | (starting from octet 1). |
| pgwNodeName | Bytes | C | 0 . . . 1 | Base64-encoded characters, |
| | | | | encoding the PGW FQDN IE |
| | | | | as specified in FIG. 8.66-1 |
| | | | | of 3GPP TS 29.274 [16] |
| | | | | (starting from octet 1). |
| | | | | It shall be present, |
| | | | | if it is available. |
| linkedBearerId | EpsBearerId | C | 0 . . . 1 | An implementation complying |
| | | | | with this version of the |
| | | | | specification shall include |
| | | | | this attribute and set it to the |
| | | | | default bearer ID associated |
| | | | | with the PDU session |
| | | | | moved to EPS. |

When Anchor SMF is reselected, the corresponding information in the Evolved Packet System (EPS) PDN Connection Context information will most likely be updated, e.g. the Internet protocol (IP) address of the S8-c F-TEID (fully qualified terminal endpoint identifier) will include the IP of the new anchor SMF. The pgwNodeName of the different SMFs most likely are different.

Currently there is no way for the new anchor SMF to inform the V-SMF/I-SMF of the updated EPS PDN Connection Context. If 5GS (fifth generation system) to EPS mobility happen, the AMF will retrieve the context from the I-SMF/V-SMF based on the old information. With the old information, the PDU session cannot be moved to EPS because MME/SGW (serving gateway) will find the wrong PGW-C/SMF in EPS.

To overcome or mitigate at least one of above mentioned problems or other problems, a solution for populating alternative PGW-C/SMF information is needed.

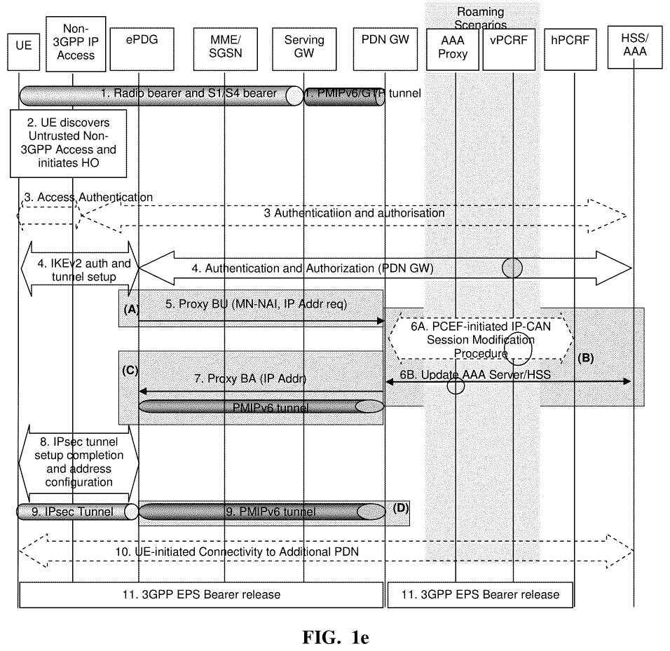

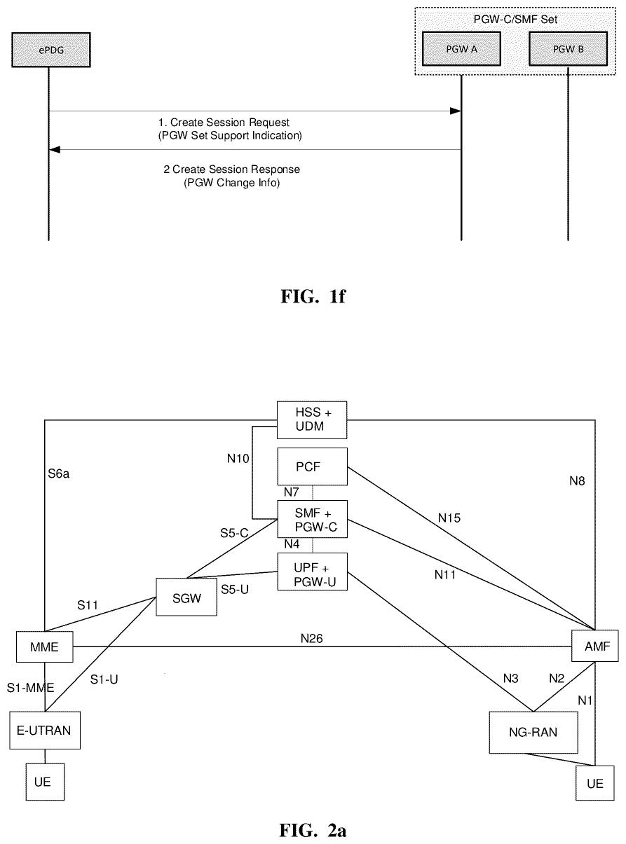

Although the subject matter described herein may be implemented in any appropriate type of system using any suitable components, the embodiments disclosed herein are described in relation to a communication system complied with the exemplary system architectures illustrated in FIGS. 2a-2c. For simplicity, the system architectures of FIGS. 2a-2c only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 2a schematically shows non-roaming architecture for interworking between 5GS and EPC/E-UTRAN. The architecture of FIG. 2a is same as FIG. 4.3.1-1 as described in 3GPP TS 23.501 V17.2.0. The system architecture of FIG. 2a may comprise some exemplary NFs such as HSS+UDM, PCF, SMF+PGW-C, UPF+PGW-U, SGW, MME, AMF, E-UTRAN, NG-RAN, UE, etc.

FIG. 2a also shows some reference points such as N10, N7, N4, S5-C, S5-U, N15, N11, S6a, N8, S11, N26, S1-U, N1, N2, N3, S1-MME, etc. For example, these reference points may be realized through corresponding interfaces and by specifying some service consumers and providers as well as their interactions in order to perform a particular system procedure.

Various NFs shown in FIG. 2a may be responsible for functions such as session management, mobility management, authentication, security, policy management, etc. The NF as shown in FIG. 2a have been described in 3GPP TS 23.501 V17.2.0 and 3GPP TS 23.401 V17.3.0, the description thereof is omitted here for brevity.

FIG. 2b schematically shows home-routed roaming architecture for interworking between 5GS and EPC/E-UTRAN. The architecture of FIG. 2b is same as FIG. 4.3.2-2 as described in 3GPP TS 23.501 V17.2.0. The system architecture of FIG. 2b may comprise some exemplary NFs such as HSS+UDM, h-PCF (home PCF), SMF+PGW-C, UPF+PGW-U, SGW, v-PCF (visited PCF), v-SMF (visited SMF), UPF, MME, AMF, E-UTRAN, NG-RAN, UE, etc.

FIG. 2b also shows some reference points such as N10, N24, N7, N16, N9, N4, S6a, N8, S5-C, S5-U, N15, N11, S11, N26, S1-U, N1, N2, N3, S1-MME, etc. For example, these reference points may be realized through corresponding interfaces and by specifying some service consumers and providers as well as their interactions in order to perform a particular system procedure.

Various NFs shown in FIG. 2b may be responsible for functions such as session management, mobility management, authentication, security, policy management, etc. The NF as shown in FIG. 2b have been described in 3GPP TS 23.501 V17.2.0 and 3GPP TS 23.401 V17.3.0, the description thereof is omitted here for brevity.

FIG. 2c schematically shows home-routed roaming architecture for interworking between ePDG/EPC and 5GS. The architecture of FIG. 2c is same as FIG. 4.3.4.2-2 as described in 3GPP TS 23.501 V17.2.0. The system architecture of FIG. 2c may comprise some exemplary NFs such as HSS+UDM, h-PCF, SMF+PGW-C, UPF+PGW-U, 3GPP AAA server, 3GPP AAA proxy, v-PCF, v-SMF, UPF, ePDG, AMF, NG-RAN, UE, etc.

FIG. 2c also shows some reference points such as SWx, N10, N7, N4, S6b, N8, N24, S2b-C, S2b-U, N16, N9, N11, N15, SWd, SWm, N1, N2, N3, etc. For example, these reference points may be realized through corresponding interfaces and by specifying some service consumers and providers as well as their interactions in order to perform a particular system procedure.

Various NFs shown in FIG. 2c may be responsible for functions such as session management, mobility management, authentication, security, policy management, etc. The NF as shown in FIG. 2c have been described in 3GPP TS 23.501 V17.2.0, 3GPP TS 23.402 V17.0.0 and 3GPP TS 23.401 V17.3.0, the description thereof is omitted here for brevity.

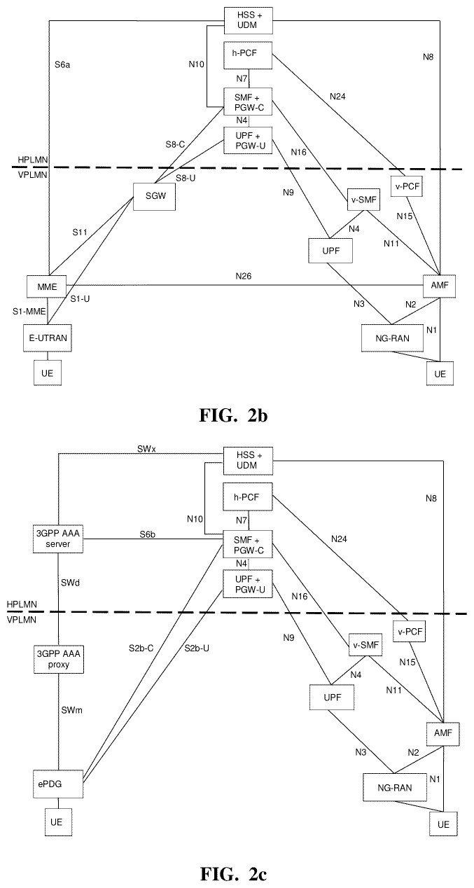

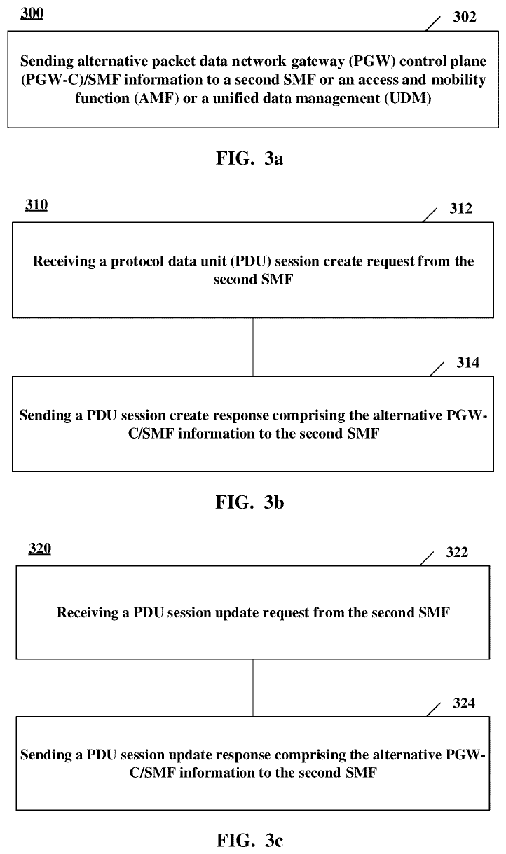

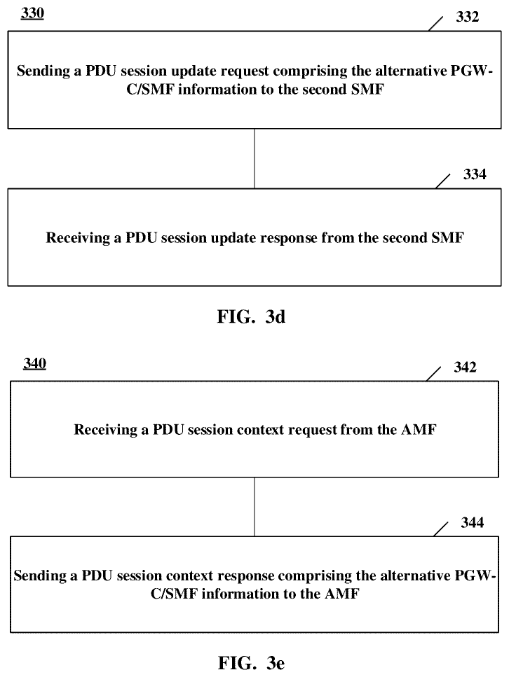

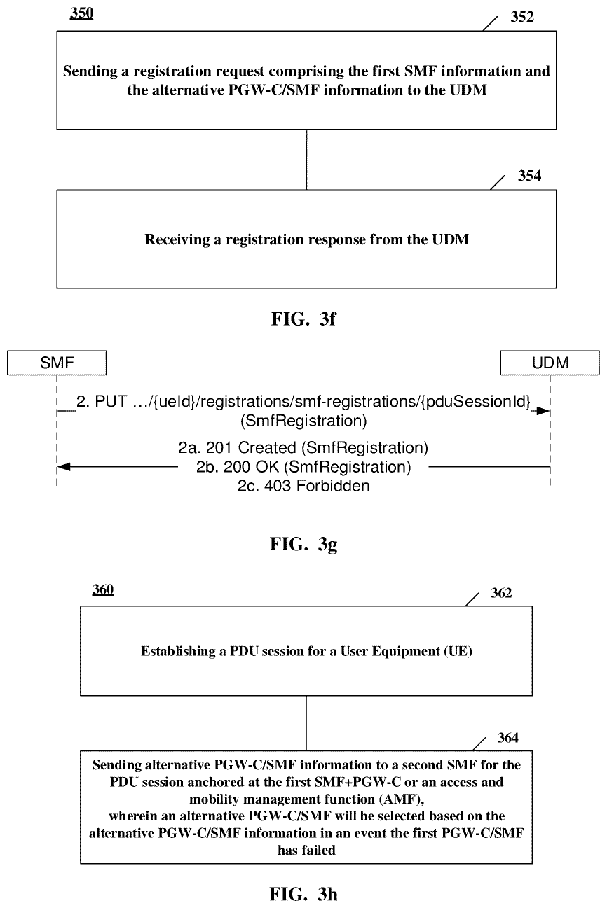

FIG. 3a shows a flowchart of a method according to an embodiment of the present disclosure, which may be performed by an apparatus implemented in or at or as first session management function (SMF) or communicatively coupled to the first SMF. As such, the apparatus may provide means or modules for accomplishing various parts of the method 300 as well as means or modules for accomplishing other processes in conjunction with other components.

At block 302, the first SMF may send alternative packet data network gateway (PGW) control plane (PGW-C)/SMF information to a second SMF or an access and mobility management function (AMF) or a unified data management (UDM).

The term “PGW-C/SMF” may refer to a combined PGW-C and SMF.

The second SMF may be any suitable SMF which requires the PGW-C/SMF information. For example, the first SMF may be an old SMF and the second SMF may be a new SMF. The first SMF may be a home PGW-C/SMF or an anchor PGW-C/SMF and the second SMF may be a new visited SMF or a new intermediate SMF.

The alternative PGW-C/SMF information may comprise any suitable information related to the alternative PGW-C/SMF. For example, the alternative PGW-C/SMF may comprise address of the alternative PGW-C/SMF or other information which can enable a network node (such as AMF, MME, ePDG, etc.) to find/or select the alternative PGW-C/SMF.

In an embodiment, the alternative PGW-C/SMF information comprises at least one of PGW Set Fully Qualified Domain Name (FQDN), alternative PGW-C/SMF Internet protocol address, or alternative PGW-C/SMF FQDN. For example, the alternative PGW-C/SMF information may be same as the PGW Change Info IE as described in 3GPP TS 29.274 V17.5.0.

The first SMF may send the PGW-C/SMF information to the second SMF or the AMF or the UDM in various ways and the present disclosure has no limit on it. For example, the first SMF may send the PGW-C/SMF information to the second SMF or the AMF or the UDM in response to a request from the second SMF or the AMF or the UDM. Alternatively, the first SMF may actively send the PGW-C/SMF information to the second SMF or the AMF or the UDM. In addition, when the PGW-C/SMF information is changed, the first SMF may actively send the PGW-C/SMF information to the second SMF or the AMF or the UDM.

The first SMF may send the PGW-C/SMF information to the second SMF or the AMF or the UDM in an existing message or a new message.

In an embodiment, the first SMF and the alternative PGW-C/SMF are functionally equivalent and inter-changeable and share same contexts. For example, the first SMF and the alternative PGW-C/SMF are deployed in a PGW-C/SMF set.

In an embodiment, the alternative PGW-C/SMF information may be used by the AMF or a mobility management entity (MME) or an evolved packet data gateway (ePDG) to select an alternative PGW-C/SMF. For example, when the AMF or MME or ePDG determines or detects that the first SMF is failed, they may select an alternative PGW-C/SMF based on alternative PGW-C/SMF information. As another example, when the AMF or MME or ePDG determines to select an alternative PGW-C/SMF due to other reasons such as load balancing, load re-balancing, etc., they may select an alternative PGW-C/SMF based on alternative PGW-C/SMF information.

FIG. 3b shows a flowchart of a method according to another embodiment of the present disclosure, which may be performed by an apparatus implemented in or at or as first SMF or communicatively coupled to the first SMF. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the first SMF may receive a protocol data unit (PDU) session create request from the second SMF. The PDU session create request may be used to create a new PDU session in the first SMF (such as H-SMF or SMF) or create an association with an existing PDN connection in the home SMF+PGW-C.

In an embodiment, the first SMF is a home PGW-C/SMF or an anchor PGW-C/SMF and the second SMF is a visited SMF or an intermediate SMF.

In an embodiment, the PDU session create request may be Nsmf_PDUSession_Create Request as described in 3GPP TS 23.502 V17.2.1. For example, the PDU session create request may be Nsmf_PDUSession_Create Request as described in step 6 of FIG. 4.3.2.2.2-1 of 3GPP TS 23.502 V17.2.1.

At block 314, the first SMF may send a PDU session create response comprising the alternative PGW-C/SMF information to the second SMF.

In an embodiment, the PDU session create response may be Nsmf_PDUSession_Create Response as described in 3GPP TS 23.502 V17.2.1 except that it further comprises the alternative PGW-C/SMF information. For example, the PDU session create response may be Nsmf_PDUSession_Create Response as described in step 13 of FIG. 4.3.2.2.2-1 of 3GPP TS 23.502 V17.2.1 except that it further comprises the alternative PGW-C/SMF information.

In an embodiment, the alternative PGW-C/SMF information is comprised in PDU session created data of the PDU session create response.

For example, Table 6.1.6.2.10-1 of 3GPP TS 29.502 V17.4.0 may add the following underlined content.

TABLE 6.1.6.2.10-1
Definition of type PduSessionCreatedData

| | | | Cardin- | | Applic- |
|---|---|---|---|---|---|
| Attribute name | Data type | P | ality | Description | ability |
| pduSessionType | PduSessionType | M | 1 | This IE shall indicate the | |
| | | | | selected PDU type. | |
| pgwChangeInfo | Bytes | C | 0 . . .1 | string with format “byte” | |
| | | | | as defined in | |
| | | | | OpenAPI Specification | |
| | | | | [15], i.e. base64-encoded | |
| | | | | characters, encoding | |
| | | | | the “PGW Change Info” | |
| | | | | IE specified in | |
| | | | | Table 7.3.1-8 or | |
| | | | | Table 7.3.6-6 of 3GPP | |
| | | | | TS 29.274 [16]for the | |
| | | | | N26 interface | |

FIG. 3c shows a flowchart of a method according to another embodiment of the present disclosure, which may be performed by an apparatus implemented in or at or as first SMF or communicatively coupled to the first SMF. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, the first SMF may receive a PDU session update request from the second SMF. The PDU session update request may be used to update the established PDU session.

In an embodiment, the first SMF is a home PGW-C/SMF or an anchor PGW-C/SMF and the second SMF is a new visited SMF or a new intermediate SMF.

In an embodiment, the PDU session update request may be Nsmf_PDUSession_Update Request as described in 3GPP TS 23.502 V17.2.1. For example, the PDU session update request may be Nsmf_PDUSession_Update Request as described in step 1a or 1e of FIG. 4.3.3.3-1 of 3GPP TS 23.502 V17.2.1.

At block 324, the first SMF may send a PDU session update response comprising the alternative PGW-C/SMF information to the second SMF.

In an embodiment, the PDU session update response may be Nsmf_PDUSession_Update Response as described in 3GPP TS 23.502 V17.2.1 except that it further comprises the alternative PGW-C/SMF information. For example, the PDU session update response may be Nsmf_PDUSession_Update Response as described in step 1a or 1e of FIG. 4.3.3.3-1 of 3GPP TS 23.502 V17.2.1 except that it further comprises the alternative PGW-C/SMF information.

In an embodiment, the alternative PGW-C/SMF information is comprised in home SMF updated data of the PDU session update response.

For example, Table 6.1.6.2.12-1 of 3GPP TS 29.502 V17.4.0 may add the following underlined content.

TABLE 6.1.6.2.12-1
Definition of type HsmfUpdatedData

| | | | Cardin- | | Applic- |
|---|---|---|---|---|---|
| Attribute name | Data type | | ality | Description | ability |
| n1SmInfoToUe | RefToBinaryData | C | 0 . . . 1 | This IE shall be present | |
| | | | | if the H-SMF/SMF | |
| | | | | needs to send N1 SM | |
| | | | | information to the UE | |
| | | | | that does not need to be | |
| | | | | interpreted by the | |
| | | | | V-SMF/I-SMF. | |
| | | | | When present, this IE shall | |
| | | | | reference the nlSmInfoToUe | |
| | | | | binary data | |
| | | | | (see clause 6.1.6.4.4). | |
| pgwChangeInfo | Bytes | C | 0 . . . 1 | string with format “byte” | |
| | | | | as defined in OpenAPI | |
| | | | | Specification [15], i.e. | |
| | | | | base64-encoded characters, | |
| | | | | encoding the | |
| | | | | “PGW Change Info” | |
| | | | | IE specified in Table | |
| | | | | 7.3.1-8 or Table 7.3.6-6 of | |
| | | | | 3GPP TS 29.274 | |
| | | | | [16]for the N26 interface | |

FIG. 3d shows a flowchart of a method according to another embodiment of the present disclosure, which may be performed by an apparatus implemented in or at or as first SMF or communicatively coupled to the first SMF. As such, the apparatus may provide means or modules for accomplishing various parts of the method 330 as well as means or modules for accomplishing other processes in conjunction with other components. For some parts which have been described in the above embodiments, the description thereof is omitted here for brevity.

At block 332, the first SMF may send a PDU session update request comprising the alternative PGW-C/SMF information to the second SMF. The PDU session update request may be used to update the established PDU session.

In an embodiment, the first SMF is a home PGW-C/SMF or an anchor PGW-C/SMF and the second SMF is a visited SMF or an intermediate SMF.

In an embodiment, the PDU session update request may be Nsmf_PDUSession_Update Request as described in 3GPP TS 23.502 V17.2.1 except that it further comprises the alternative PGW-C/SMF information. For example, the PDU session update request may be Nsmf_PDUSession_Update Request as described in step 3 of FIG. 4.3.3.3-1 of 3GPP TS 23.502 V17.2.1 except that it further comprises the alternative PGW-C/SMF information except that it further comprises the alternative PGW-C/SMF information.

At block 334, the first SMF may receive a PDU session update response from the second SMF.

In an embodiment, the PDU session update response may be Nsmf_PDUSession_Update Response as described in 3GPP TS 23.502 V17.2.1. For example, the PDU session update response may be Nsmf_PDUSession_Update Response as described in step 15 of FIG. 4.3.3.3-1 of 3GPP TS 23.502 V17.2.1.

In an embodiment, the alternative PGW-C/SMF information is comprised in visited SMF update data of the PDU session update request.

For example, Table 6.1.6.2.15-1 of 3GPP TS 29.502 V17.4.0 may add the following underlined content.

TABLE 6.1.6.2.15-1
Definition of type VsmfUpdateData

| | | | Cardin- | | Applic- |
|---|---|---|---|---|---|
| Attribute name | Data type | P | ality | Description | ability |
| requestIndication | Request- | M | 1 | This IE shall indicate | |
| | Indication | | | the request type. | |
| sessionAmbr | Ambr | C | 1 | This IE shall be present if the Session | |
| | | | | AMBR authorized for | |
| | | | | the PDU session is | |
| | | | | modified. When present, it shall | |
| | | | | contain the new Session AMBR | |
| | | | | authorized for the PDU session. | |
| pgwChangeInfo | Bytes | C | 0 . . . 1 | string with format “byte”as defined in | |
| | | | | OpenAPI Specification [15], i.e. | |
| | | | | base64-encoded characters, | |
| | | | | encoding the “PGW Change Info” | |
| | | | | IE specified in Table | |
| | | | | 7.3.1-8 or Table 7.3.6-6 | |
| | | | | of 3GPP TS 29.274 | |
| | | | | [16]for the N26 interface | |

According to various embodiments, for a home routed PDU session or a PDU session with an I-SMF involved, it requires the first SMF such as a combined PGW-C/SMF to always provide “PGW Change Info” (as string with format “byte” as defined in OpenAPI Specification (OpenAPI Initiative, “OpenAPI Specification Version 3.0.0”, https://spec.openapis.org/oas/v3.0.0), i.e. base64-encoded characters, encoding the “PGW Change Info” IE specified in Table 7.3.1-8 or Table 7.3.6-6 of 3GPP TS 29.274 V17.5.0 for the N26 interface. (See clause 2 for more information)) to the V/I-SMF, e.g. in PduSessionCreatedData (e.g. for a PDU session establishment), HsmfUpdatedData (e.g. for a V/I-SMF change procedure) and VsmfUpdateData (e.g. when the combined PGW-C/SMF wish to change “PGW Change Info”.

In an embodiment, when the second SMF such as V/I-SMF receives “PGW Change Info”, it shall store it and include it in the SmContextRetrievedData as described in clause 6.1.6.2.27 of 3GPP TS 29.502 V17.4.0 during a 5G to 4G mobility procedure.

FIG. 3e shows a flowchart of a method according to another embodiment of the present disclosure, which may be performed by an apparatus implemented in or at or as first SMF or communicatively coupled to the first SMF. As such, the apparatus may provide means or modules for accomplishing various parts of the method 340 as well as means or modules for accomplishing other processes in conjunction with other components. For some parts which have been described in the above embodiments, the description thereof is omitted here for brevity.

At block 342, the first SMF may receive a PDU session context request from the AMF. The PDU session context request may be used by the AMF to request for SM (session management) Context.

In an embodiment, the first SMF may be a home PGW-C/SMF or an anchor PGW-C/SMF or visited SMF or I-SMF.

In an embodiment, the PDU session context request may be Nsmf_PDUSession_ContextRequest as described in 3GPP TS 23.502 V17.2.1. For example, the PDU session context request may be Nsmf_PDUSession_ContextRequest as described in step 2a of FIG. 4.11.1.2.1-1 of 3GPP TS 23.502 V17.2.1. In another example, the PDU session context request may be Nsmf_PDUSession_ContextRequest as described in step 5a of FIG. 4.11.1.3.2-1 of 3GPP TS 23.502 V17.2.1.

At block 344, the first SMF may send a PDU session context response comprising the alternative PGW-C/SMF information to the AMF.

In an embodiment, the PDU session context response may be Nsmf_PDUSession_ContextReponse as described in 3GPP TS 23.502 V17.2.1 except that it further comprises the alternative PGW-C/SMF information. For example, the PDU session context response may be Nsmf_PDUSession_ContextReponse as described in step 2c of FIG. 4.11.1.2.1-1 of 3GPP TS 23.502 V17.2.1 except that it further comprises the alternative PGW-C/SMF information. In another example, the PDU session context response may be Nsmf_PDUSession_ContextReponse as described in step 5c of FIG. 4.11.1.3.2-1 of 3GPP TS 23.502 V17.2.1 except that it further comprises the alternative PGW-C/SMF information.

In an embodiment, when receiving SmContext Retrieve Request from the AMF where the UE is moving from 5G to 4G, it requires that the first SMF such as a combined PGW-C/SMF shall include “PGW Change Info” as part EpSPdnCnxContainer to be included in the SmContextRetrievedData as described in clause 6.1.6.2.27 of 3GPP TS 29.502 V17.4.0.

FIG. 3f shows a flowchart of a method according to another embodiment of the present disclosure, which may be performed by an apparatus implemented in or at or as first SMF or communicatively coupled to the first SMF. As such, the apparatus may provide means or modules for accomplishing various parts of the method 350 as well as means or modules for accomplishing other processes in conjunction with other components. For some parts which have been described in the above embodiments, the description thereof is omitted here for brevity.

At block 352, the first SMF may send a registration request comprising the first SMF information and the alternative PGW-C/SMF information to the UDM. For example, the registration request may be used to register session's serving NF on the UDM

In an embodiment, the registration request may be the Nudm_UECM_Registration Request as described in 3GPP TS 23.502 V17.2.1. For example, the registration request may be the Nudm_UECM_Registration Request as described in step 12c of FIG. 4.3.2.2.2-1 of 3GPP TS 23.502 V17.2.1.

At block 354, the first SMF may receive a registration response from the UDM.

In an embodiment, the registration response may be the Nudm_UECM_Registration Response as described in 3GPP TS 23.502 V17.2.1. For example, the registration response may be the Nudm_UECM_Registration Response as described in step 12c of FIG. 4.3.2.2.2-1 of 3GPP TS 23.502 V17.2.1.

In an embodiment, the first SMF such as the combined PGW-C/SMF includes the “PGW Change Info” in the SmfRegistration to UDM, when the combined PGW-C/SMF registers the PDU session and sends a Nudm_UECM_Registration request (with the data type is SmfRegistration as specified in 3GPP TS 29.503 V17.6.0), this will enable that a network node such as ePDG can retrieve the “PGW change info” from the UDM/HSS/AAA, to be used for reselection if needed, when UE moves from 5G to non-3gpp access in 4G.

FIG. 3g shows a flowchart of SMF registration according to an embodiment of the present disclosure.

At step 1. The SMF sends a PUT request to the resource . . . /{ueld}/registrations/smf-registrations/{pduSessionld}, to create an SMF Registration as present in the message body. The PUT request comprises the first SMF information and the alternative PGW-C/SMF information.

If the SMF belongs to an SMF Set, the NF Set ID of the SMF Set shall be included in the request message.

If EPS interworking is supported, the SMF+PGW-C shall include the PCF ID selected for the PDU session to the UDM when the SMF+PGW-C register in the UDM.

At step 2a. The UDM responds with “201 Created” with the message body containing a representation of the created SMF registration.

At step 2b. If the individual resource exists, on success, the UDM updates the resource by replacing it with the received resource information, and responds with “200 OK” with the message body containing a representation of the updated Individual SmfRegistration resource.

If the new SMF is not in a SMF set or is not in the same SMF Set as the old SMF, the UDM shall invoke the Deregistration Notification service operation towards the old SMF using the callback URI provided by the old SMF.

At step 2c. If the operation cannot be authorized due to e.g. UE does not have required subscription data, access barring or roaming restrictions, HTTP (hypertext transport protocol) status code “403 Forbidden” should be returned including additional error information in the response body (in “ProblemDetails” element). Subscription information associated to a specific DNN (if any) shall take precedence over subscription information associated to the Wildcard DNN.

On failure, the appropriate HTTP status code indicating the error shall be returned and appropriate additional error information should be returned in the PUT response body.

In an embodiment, the alternative PGW-C/SMF information is comprised in SMF registration data of the registration request.

In an embodiment, Table 6.2.6.2.4-1 of 3GPP TS 29.503 V17.6.0 may add the following underlined content.

TABLE 6.2.6.2.4-1
Definition of type SmfRegistration

| | | | Cardin- | |
|---|---|---|---|---|
| Attribute name | Data type | P | alit | Description |
| smfInstanceId | NfInstanceId | M | 1 | NF Instance Id of the SMF |
| smfSetId | NfSetId | C | 0 . . . 1 | This IE shall be present if the |
| | | | | SMF belongs to a SMF SET. |
| | | | | If present, it indicates the NF |
| | | | | Set ID of SMF Set. |
| supportedFeatures | Supported- | O | 0 . . . 1 | See clause 6.2.8 |
| | Features | | | These are the features |
| | | | | supportedby the SMF. |
| pduSessionId | PduSessionId | M | | PDU Session ID |
| pgwChangeInfo | Bytes | C | 0 . . . 1 | string with format “byte” |
| | | | | as defined in |
| | | | | OpenAPI Specification |
| | | | | [15], i.e. base64-encoded |
| | | | | characters, |
| | | | | encoding the |
| | | | | “PGW Change Info”IE |
| | | | | specified in Table 7.3.1-8 or |
| | | | | Table 7.3.6-6 of 3GPP TS |
| | | | | 29.274 [16]for the |
| | | | | N26 interface. |

FIG. 3h shows a flowchart of a method according to another embodiment of the present disclosure, which may be performed by an apparatus implemented in or at or as first PGW-C/SMF or communicatively coupled to the first PGW-C/SMF. As such, the apparatus may provide means or modules for accomplishing various parts of the method 360 as well as means or modules for accomplishing other processes in conjunction with other components. For some parts which have been described in the above embodiments, the description thereof is omitted here for brevity.

At block 362, the first PGW-C/SMF may establish a PDU session for a User Equipment (UE).

At block 364, the first PGW-C/SMF may send alternative PGW-C/SMF information to a second SMF for the PDU session anchored at the first SMF+PGW-C or an access and mobility management function (AMF).

In an embodiment, an alternative PGW-C/SMF will be selected based on the alternative PGW-C/SMF information in an event the first PGW-C/SMF has failed.

In an embodiment, sending the alternative PGW-C/SMF information to the second SMF may comprise receiving a protocol data unit (PDU) session create request from the second SMF. The method may further comprise sending a PDU session create response comprising the alternative PGW-C/SMF information to the second SMF.

In an embodiment, the alternative PGW-C/SMF information may be comprised in PDU session created data of the PDU session create response.

In an embodiment, the first PGW-C/SMF may be a home PGW-C/SMF or an anchor PGW-C/SMF and/or the second SMF may be a visited SMF or an intermediate SMF.

In an embodiment, sending the alternative PGW-C/SMF information to the second SMF may comprise receiving a PDU session update request from the second SMF and sending a PDU session update response comprising the alternative PGW-C/SMF information to the second SMF.

In an embodiment, the alternative PGW-C/SMF information may be comprised in home SMF updated data of the PDU session update response.

In an embodiment, the first PGW-C/SMF may be a home PGW-C/SMF or an anchor PGW-C/SMF and/or the second SMF may be a new visited SMF or a new intermediate SMF.

In an embodiment, sending the alternative PGW-C/SMF information to the second SMF may comprise sending a PDU session update request comprising the alternative PGW-C/SMF information to the second SMF and receiving a PDU session update response from the second SMF.

In an embodiment, the alternative PGW-C/SMF information may be comprised in visited SMF update data of the PDU session update request.

In an embodiment, the first PGW-C/SMF may be a home PGW-C/SMF or an anchor PGW-C/SMF and/or the second SMF may be a visited SMF or an intermediate SMF.

In an embodiment, sending the alternative PGW-C/SMF information to the AMF may comprise receiving a PDU session context request from the AMF and sending a PDU session context response comprising the alternative PGW-C/SMF information to the AMF.

In an embodiment, the alternative PGW-C/SMF information may comprise information of at least one PGW-C/SMF, so that the alternative PGW-C/SMF can be selected.

In an embodiment, the alternative PGW-C/SMF information may be used by the AMF or a mobility management entity (MME) or an evolved packet data gateway (ePDG) to select an alternative PGW-C/SMF.

In an embodiment, the first PGW-C/SMF and the alternative PGW-C/SMF may be functionally equivalent and inter-changeable and share same contexts.

FIG. 4a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the second SMF may receive alternative packet data network gateway (PGW) control plane (PGW-C)/SMF information from a first SMF.

For example, in the above embodiments, the first SMF may send the alternative PGW-C/SMF information to the second SMF, and then the second SMF may receive the alternative PGW-C/SMF information. After receiving the alternative PGW-C/SMF information, the second SMF may store the alternative PGW-C/SMF information.

At block 404, the second SMF may send the alternative PGW-C/SMF information to an access and mobility management function (AMF).

The second SMF may send the alternative PGW-C/SMF information to the AMF in various ways and the present disclosure has no limit on it. For example, the second SMF may send the alternative PGW-C/SMF information to the AMF in response to a request from the AMF. Alternatively, the second SMF may actively send the alternative PGW-C/SMF information to the AMF. In addition, when the PGW-C/SMF information is changed, the second SMF may send the alternative PGW-C/SMF information to the AMF.

The second SMF may send the alternative PGW-C/SMF information to the AMF in an existing message or a new message.

In an embodiment, the alternative PGW-C/SMF information comprises at least one of PGW Set Fully Qualified Domain Name (FQDN), alternative PGW-C/SMF Internet protocol address, or alternative PGW-C/SMF FQDN.

In an embodiment, the alternative PGW-C/SMF information is used by the AMF or a mobility management entity (MME) or an evolved packet data gateway (ePDG) to select an alternative PGW-C/SMF.

In an embodiment, the first session management function (SMF) and the alternative PGW-C/SMF are functionally equivalent and inter-changeable and share same contexts.

FIG. 4b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the second SMF may send a PDU session create request to the first SMF.

At block 414, the second SMF may receive a PDU session create response comprising the alternative PGW-C/SMF information from the first SMF.

In an embodiment, the alternative PGW-C/SMF information is comprised in PDU session created data of the PDU session create response.

In an embodiment, the first SMF is a home PGW-C/SMF or an anchor PGW-C/SMF and the second SMF is a visited SMF or an intermediate SMF.

FIG. 4c shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the second SMF may send a PDU session update request to the first SMF.

At block 424, the second SMF may receive a PDU session update response comprising the alternative PGW-C/SMF information from the first SMF.

In an embodiment, the alternative PGW-C/SMF information is comprised in home SMF updated data of the PDU session update response.

In an embodiment, the first SMF is a home PGW-C/SMF or an anchor PGW-C/SMF and the second SMF is a new visited SMF or a new intermediate SMF.

FIG. 4d shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 430 as well as means or modules for accomplishing other processes in conjunction with other components. For some parts which have been described in the above embodiments, the description thereof is omitted here for brevity.

At block 432, the second SMF may receive a PDU session update request comprising the alternative PGW-C/SMF information from the first SMF.

At block 434, the second SMF may send a PDU session update response to the first SMF.

In an embodiment, the alternative PGW-C/SMF information is comprised in visited SMF update data of the PDU session update request.

In an embodiment, the first SMF is a home PGW-C/SMF or an anchor PGW-C/SMF and the second SMF is a visited SMF or an intermediate SMF.

FIG. 4e shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 440 as well as means or modules for accomplishing other processes in conjunction with other components. For some parts which have been described in the above embodiments, the description thereof is omitted here for brevity.

At block 442, the second SMF may receive a PDU session context request from the AMF.

At block 444, the second SMF may send a PDU session context response comprising the alternative PGW-C/SMF information to the AMF.

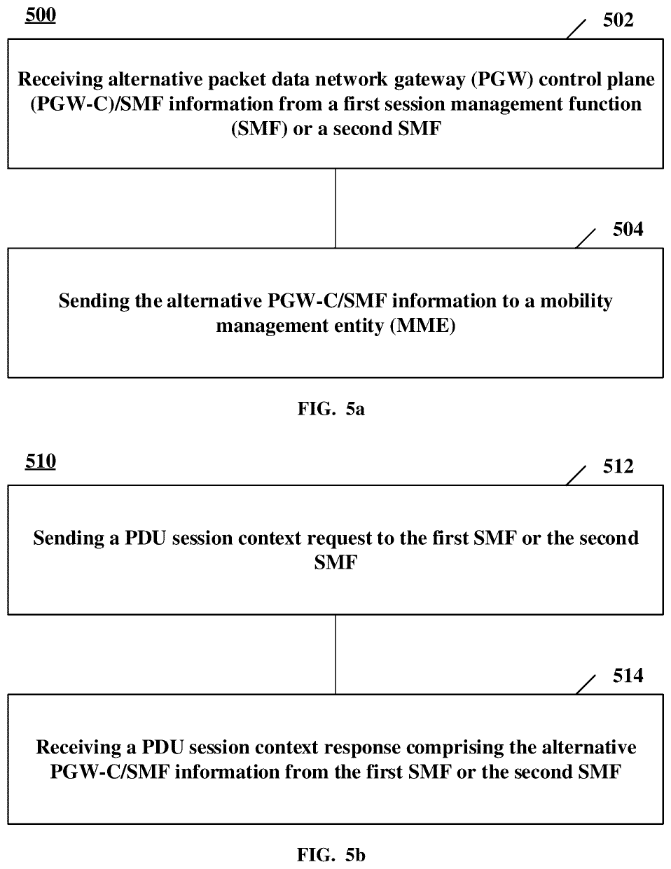

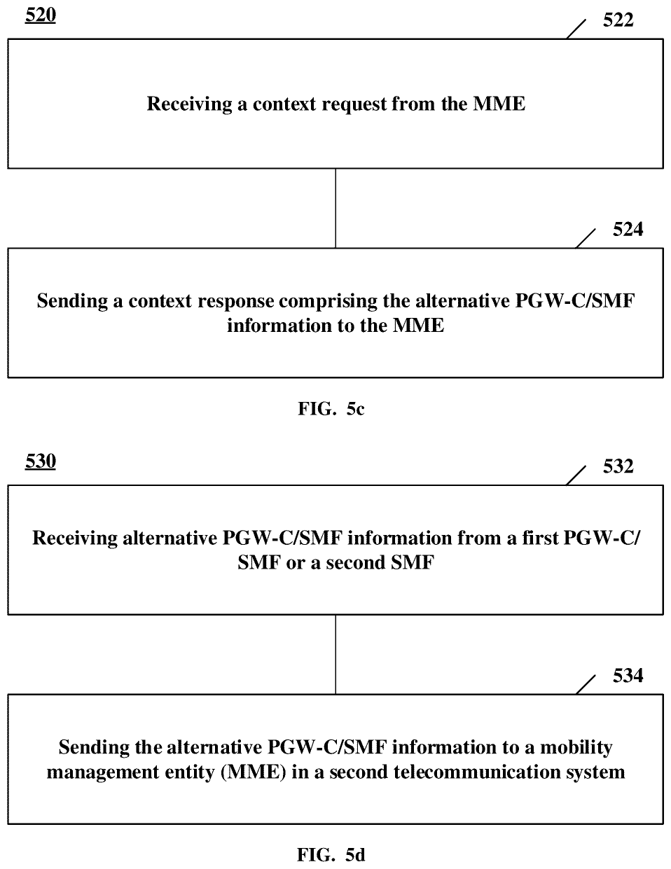

FIG. 5a shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the AMF may receive alternative packet data network gateway (PGW) control plane (PGW-C)/SMF information from a first session management function (SMF) or a second SMF.

For example, in the above embodiments, the first SMF or the second SMF may send the alternative PGW-C/SMF information to the AMF, and then the AMF may receive the alternative PGW-C/SMF information from the first SMF or the second SMF.

In an embodiment, the first SMF is a home PGW-C/SMF or an anchor PGW-C/SMF and the second SMF is a visited SMF or an intermediate SMF.

In an embodiment, the alternative PGW-C/SMF information comprises at least one of PGW Set Fully Qualified Domain Name (FQDN), alternative PGW-C/SMF Internet protocol address, or alternative PGW-C/SMF FQDN.

In an embodiment, the alternative PGW-C/SMF information is used by the AMF or a mobility management entity (MME) or an evolved packet data gateway (ePDG) to select an alternative PGW-C/SMF.

In an embodiment, the first session management function (SMF) and the alternative PGW-C/SMF are functionally equivalent and inter-changeable and share same contexts.

At block 504, the AMF may send the alternative PGW-C/SMF information to a mobility management entity (MME).

The AMF may send the alternative PGW-C/SMF information to the MME in various ways and the present disclosure has no limit on it. For example, the AMF may send the alternative PGW-C/SMF information to the MME in response to a request from the MME. Alternatively, the AMF may actively send the alternative PGW-C/SMF information to the MME in response to a request from the MME.

The AMF may send the alternative PGW-C/SMF information to the MME in an existing message or a new message.

FIG. 5b shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, the AMF may send a PDU session context request to the first SMF or the second SMF.

At block 514, the AMF may receive a PDU session context response comprising the alternative PGW-C/SMF information from the first SMF or the second SMF.

FIG. 5c shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 520 as well as means or modules for accomplishing other processes in conjunction with other components. For some parts which have been described in the above embodiments, the description thereof is omitted here for brevity.

At block 522, the AMF may receive a context request from the MME.

In an embodiment, the context request may be the context request as described in step 4 of FIG. 4.11.1.3.2-1 of 3GPP TS 23.502 V17.2.1.

At block 524, the AMF may send a context response comprising the alternative PGW-C/SMF information to the MME.

In an embodiment, the context request may be the context response as described in step 6 of FIG. 4.11.1.3.2-1 of 3GPP TS 23.502 V17.2.1 except that it further comprises the alternative PGW-C/SMF information.

FIG. 5d shows a flowchart of a method according to another embodiment of the present disclosure, which may be performed by an apparatus implemented in or at or as an AMF in a first telecommunication system or communicatively coupled to the AMF in the first telecommunication system. As such, the apparatus may provide means or modules for accomplishing various parts of the method 530 as well as means or modules for accomplishing other processes in conjunction with other components. For some parts which have been described in the above embodiments, the description thereof is omitted here for brevity.

At block 532, the AMF may receive alternative packet data network gateway control plane/Session Management Function (PGW-C/SMF) information from a first PGW-C/SMF or a second SMF.

At block 534, the AMF may send the alternative PGW-C/SMF information to a mobility management entity (MME) in a second telecommunication system.

In an embodiment, receiving the alternative PGW-C/SMF information from the first PGW-C/SMF or the second SMF may comprise sending a Protocol Data Unit (PDU) session context request to the first PGW-C/SMF or the second SMF and receiving a PDU session context response comprising the alternative PGW-C/SMF information from the first PGW-C/SMF or the second SMF.

In an embodiment, sending the alternative PGW-C/SMF information to the MME may comprises receiving a context request from the MME and sending a context response comprising the alternative PGW-C/SMF information to the MME.

In an embodiment, the first PGW-C/SMF may be a home PGW-C/SMF or an anchor PGW-C/SMF and/or the second SMF may be a visited SMF or an intermediate SMF.

In an embodiment, the alternative PGW-C/SMF information may comprise information of at least one PGW-C/SMF, so that an alternative PGW-C/SMF can be selected.

In an embodiment, the alternative PGW-C/SMF information may be used by the AMF or the MME or an evolved packet data gateway (ePDG) to select an alternative PGW-C/SMF.

In an embodiment, the first PGW-C/SMF and the alternative PGW-C/SMF may be functionally equivalent and inter-changeable and share same contexts.

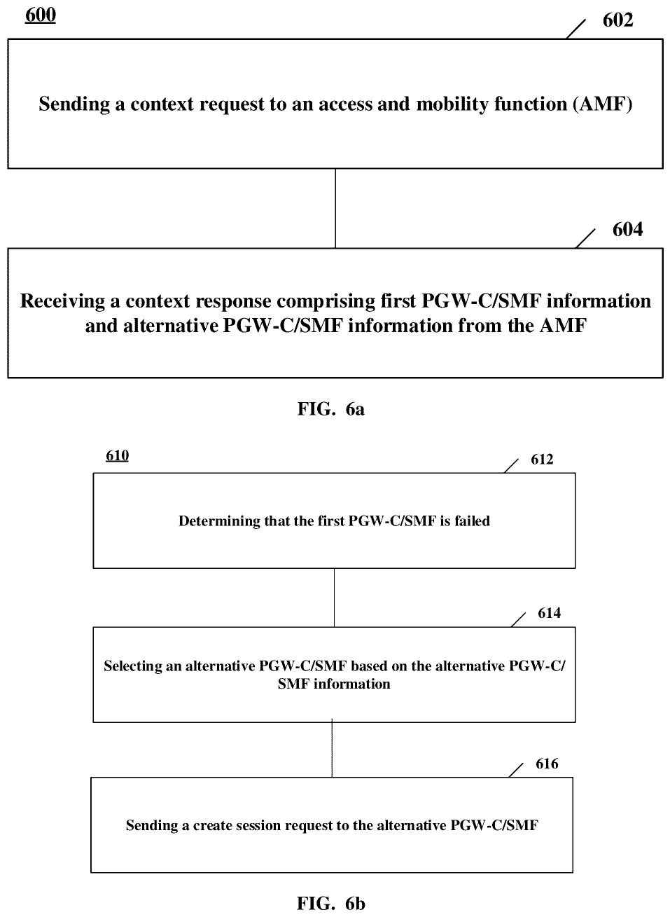

FIG. 6a shows a flowchart of a method according to another embodiment of the present disclosure, which may be performed by an apparatus implemented in or at or as an MME or communicatively coupled to the MME. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the MME may send a context request to an access and mobility management function (AMF).

At block 604, the MME may receive a context response comprising first PGW-C/SMF information and alternative PGW-C/SMF information from the AMF.

In an embodiment, the MME may receive a context response comprising first session management function (SMF) information and alternative packet data network gateway (PGW) control plane (PGW-C)/SMF information from the AMF.

In an embodiment, the first PGW-C/SMF is a home PGW-C/SMF or an anchor PGW-C/SMF.

In an embodiment, the first PGW-C/SMF and the alternative PGW-C/SMF are functionally equivalent and inter-changeable and share same contexts.

In an embodiment, the alternative PGW-C/SMF information comprises information of at least one PGW-C/SMF, so that the alternative PGW-C/SMF can be selected.

In an embodiment, the alternative PGW-C/SMF information comprises at least one of PGW Set Fully Qualified Domain Name (FQDN), alternative PGW-C/SMF Internet protocol address, or alternative PGW-C/SMF FQDN.

FIG. 6b shows a flowchart of a method according to another embodiment of the present disclosure, which may be performed by an apparatus implemented in or at or as an MME or communicatively coupled to the MME. As such, the apparatus may provide means or modules for accomplishing various parts of the method 610 as well as means or modules for accomplishing other processes in conjunction with other components. For some parts which have been described in the above embodiments, the description thereof is omitted here for brevity.

At block 612, the MME may determine that the first PGW-C/SMF is failed. In an embodiment, the MME may determine that the first SMF is failed. The MME may determine that the first SMF is failed in various ways. For example, the MME may send a message to the first SMF. If the MME can not receive a response from the first AMF, the MME may determine that the first SMF is failed. The MME may determine that the first SMF is failed based on a heartbeat message. Another network node such as SGW may report that the first SMF is failed, and then the MME may determine that the first SMF is failed.

At block 614, the MME may select an alternative PGW-C/SMF based on the alternative PGW-C/SMF information. For example, when the alternative PGW-C/SMF comprises the PGW-C/SMF Internet protocol address, it may select this PGW-C/SMF.

At block 616, the MME may send a create session request to the alternative PGW-C/SMF.

In an embodiment, the create session request may be same as the create session request as specified in 3GPP TS 23.401 V17.3.0.

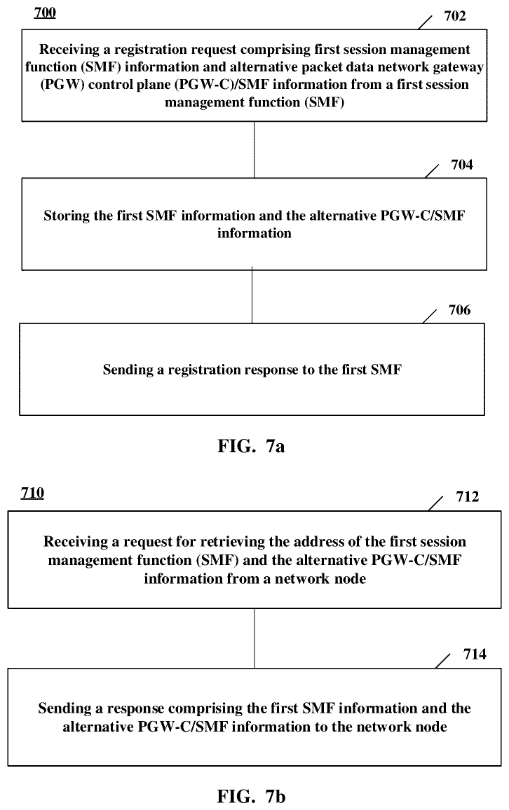

FIG. 7a shows a flowchart of a method according to another embodiment of the present disclosure, which may be performed by an apparatus implemented in or at or as a UDM or communicatively coupled to the UDM. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the UDM may receive a registration request comprising first session management function (SMF) information and alternative packet data network gateway (PGW) control plane (PGW-C)/SMF information from a first session management function (SMF).

At block 704, the UDM may store the first SMF information and the alternative PGW-C/SMF information.

At block 706, the UDM may send a registration response to the first SMF.

In an embodiment, the alternative PGW-C/SMF information comprises at least one of PGW Set Fully Qualified Domain Name (FQDN), alternative PGW-C/SMF Internet protocol address, or alternative PGW-C/SMF FQDN.

In an embodiment, the alternative PGW-C/SMF information is used by an access and mobility management function (AMF) or a mobility management entity (MME) or an evolved packet data gateway (ePDG) to select an alternative PGW-C/SMF.

In an embodiment, the first SMF and the alternative PGW-C/SMF are functionally equivalent and inter-changeable and share same contexts.

In an embodiment, the first SMF is a home PGW-C/SMF or an anchor PGW-C/SMF.

In an embodiment, the first SMF information and the alternative PGW-C/SMF information are comprised in SMF registration data of the registration request.

FIG. 7b shows a flowchart of a method according to another embodiment of the present disclosure, which may be performed by an apparatus implemented in or at or as a UDM or communicatively coupled to the UDM. As such, the apparatus may provide means or modules for accomplishing various parts of the method 710 as well as means or modules for accomplishing other processes in conjunction with other components. For some parts which have been described in the above embodiments, the description thereof is omitted here for brevity.

At block 712, the UDM may receive a request for retrieving the address of the first session management function (SMF) and the alternative PGW-C/SMF information from a network node.

The network node may be any suitable network node such as AMF, SMF, MME, ePDG, etc. In an embodiment, the network node is an evolved packet data gateway (ePDG).

At block 714, the UDM may send a response comprising the first SMF information and the alternative PGW-C/SMF information to the network node.

For example, at step 4 of FIG. 8.2.3-1 of 3GPP TS 23.402 V17.0.0, as part of access authentication, the first SMF information and the alternative PGW-C/SMF information are sent to the ePDG by the 3GPP AAA server. 3GPP AAA server may retrieve the first SMF information and the alternative PGW-C/SMF information from UDM.

FIG. 8a shows a flowchart of a method according to another embodiment of the present disclosure, which may be performed by an apparatus implemented in or at or as an ePDG or communicatively coupled to the ePDG. As such, the apparatus may provide means or modules for accomplishing various parts of the method 800 as well as means or modules for accomplishing other processes in conjunction with other components. For some parts which have been described in the above embodiments, the description thereof is omitted here for brevity.

At block 802, the ePDG may send a request for retrieving first session management function (SMF) information and alternative packet data network gateway (PGW) control plane (PGW-C)/SMF information to a unified data management (UDM). For example, the ePDG may send the request to 3GPP AAA server which may send the request to UDM.

At block 804, the ePDG may receive a response comprising the first SMF information and the alternative PGW-C/SMF information from the UDM. For example, the ePDG may receive the response from 3GPP AAA server which may receive the response from UDM.

In an embodiment, the first SMF is a home PGW-C/SMF or an anchor PGW-C/SMF.

In an embodiment, the first SMF and the alternative PGW-C/SMF are functionally equivalent and inter-changeable and share same contexts.

In an embodiment, the alternative PGW-C/SMF information comprises at least one of PGW Set Fully Qualified Domain Name (FQDN), alternative PGW-C/SMF Internet protocol address, or alternative PGW-C/SMF FQDN.

FIG. 8b shows a flowchart of a method according to another embodiment of the present disclosure, which may be performed by an apparatus implemented in or at or as an ePDG or communicatively coupled to the ePDG. As such, the apparatus may provide means or modules for accomplishing various parts of the method 810 as well as means or modules for accomplishing other processes in conjunction with other components. For some parts which have been described in the above embodiments, the description thereof is omitted here for brevity.

At block 812, the ePDG may determine that the first SMF is failed. The ePDG may determine that the first SMF is failed in various ways. For example, the ePDG may send a message to the first SMF. If the ePDG can not receive a response from the first AMF, the ePDG may determine that the first SMF is failed. The ePDG may determine that the first SMF is failed based on a heartbeat message. Another network node may report that the first SMF is failed, and then the ePDG may determine that the first SMF is failed.

At block 814, the ePDG may select an alternative PGW-C/SMF based on the alternative PGW-C/SMF information. For example, when the alternative PGW-C/SMF comprises the PGW-C/SMF Internet protocol address, it may select this PGW-C/SMF.

At block 816, the ePDG may send a create session request to the alternative PGW-C/SMF.

In an embodiment, the create session request may be same as the create session request as specified in 3GPP TS 23.402 V17.0.0.

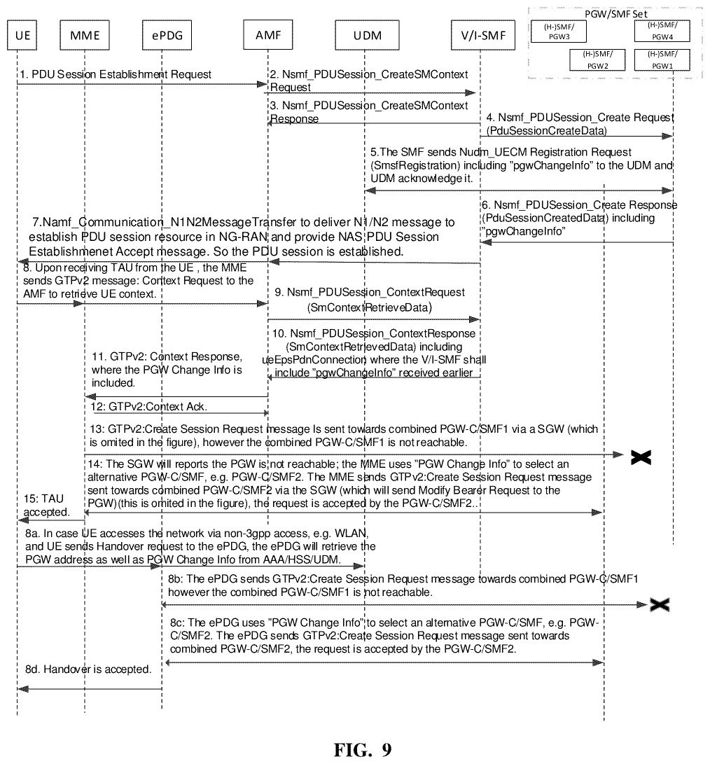

FIG. 9 shows a flowchart of how PGW Change Info is to be added in various signaling messages according to another embodiment of the present disclosure.

Steps 1-7 are for PDU session establishment for a Home Routed PDU session or a PDU session with an I-SMF. And then UE moves from 5G to 4G, steps 8-15 for UE moving from 5G to EPS. Steps 8a to 8d for UE moving from 5G to ePDG.

At step 1. UE sends PDU Session Establishment Request to AMF.

At step 2. AMF sends Nsmf_PDUSession_CreateSMContext Request to V/I-SMF.

At step 3. AMF receives Nsmf_PDUSession_CreateSMContext Response from V/I-SMF.

At step 4. V/I-SMF sends Nsmf_PDUSession_Create Request (PduSessionCreateData) to (H-) SMF/PGW1.

At step 5. The (H-) SMF/PGW1 sends Nudm_UECM Registration Request (SmsfRegistration) including “pgwChangeInfo” to the UDM and UDM acknowledge it.

At step 6. (H-) SMF/PGW1 sends Nsmf_PDUSession_Create Response (PduSessionCreatedData) including “pgwChangeInfo” to V/I-SMF.

At step 7. V/I-SMF sends Namf_Communication_N1N2MessageTransfer to deliver N1/N2 message to establish PDU session resource in NG-RAN and provide Non-Access-Statum (NAS) PDU Session Establishment Accept message to UE. So the PDU session is established.

At step 8. Upon receiving TAU (tacking area update) from the UE, the MME sends GTPv2 message: Context Request to the AMF to retrieve UE context.

At step 9. AMF sends Nsmf_PDUSession_ContextRequest (SmContextRetrieveData) to V/I-SMF.

At step 10. V/I-SMF sends Nsmf_PDUSession_ContextResponse (SmContextRetrievedData) including ueEpsPdnConnection to AMF, where the V/I-SMF shall include “pgwChangeInfo” received earlier.

At step 11. AMF sends GTPv2: Context Response to MME, where the PGW Change Info is included.

At step 12: MME sends GTPv2: Context Ack (acknowledge) to AMF.

At step 13: MME send GTPv2: Create Session Request message towards combined PGW-C/SMF1 via a SGW (which is omitted in the figure), however the combined PGW-C/SMF1 is not reachable.

At step 14: The SGW will reports that the combined PGW-C/SMF1 is not reachable. The MME uses “PGW Change Info” to select an alternative PGW-C/SMF, e.g. PGW-C/SMF2. The MME sends GTPv2: Create Session Request message sent towards the combined PGW-C/SMF2 via the SGW (which will send Modify Bearer Request to the combined PGW-C/SMF2) (this is omitted in the figure), the request is accepted by the PGW-C/SMF2.

At step 15: MME sends TAU accepted to UE.

At step 8a. In case UE accesses the network via non-3gpp access, e.g. WLAN (Wireless Local Area Network), and UE sends Handover request to the ePDG, the ePDG will retrieve the PGW address as well as PGW Change Info from AAA/HSS/UDM.

At step 8b: The ePDG sends GTPv2: Create Session Request message sent towards combined PGW-C/SMF1. However the combined PGW-C/SMF1 is not reachable.

At step 8c: The ePDG uses “PGW Change Info” to select an alternative PGW-C/SMF, e.g. PGW-C/SMF2. The ePDG sends GTPv2: Create Session Request message sent towards the combined PGW-C/SMF2 and the request is accepted by the PGW-C/SMF2.

At step 8d. ePDG sends “Handover is accepted” to UE.

Some messages of FIG. 9 may be same as the corresponding message as described in 3GPP specifications such as 3GPP TS 23.401 V17.3.0, 3GPP TS 23.502 V17.2.1, or 3GPP TS 23.402 V17.0.0. Some messages of FIG. 9 may be enhanced to comprise “PGW Change Info”. In addition, when MME or ePDG determines a combined PGW-C/SMF is not reachable, the MME or ePDG may use “PGW Change Info” to select an alternative PGW-C/SMF. And then the MME o ePDG sends GTPv2: Create Session Request message sent towards the alternative PGW-C/SMF. In this ways, it can secure that the PDU session can successfully move from 5G to 4G mobility even when the serving combined PGW-C/SMF has failed (as long as it pertains to a combined PGW-C/SMF set).

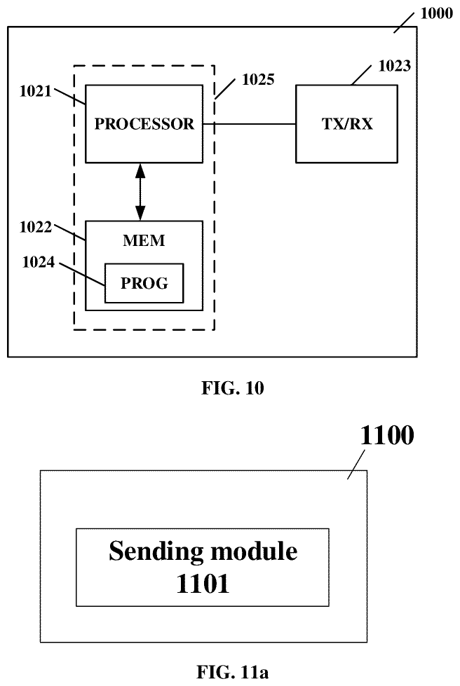

FIG. 10 is a block diagram showing an apparatus suitable for practicing some embodiments of the disclosure. For example, any one of the first SMF, the first PGW-C/SMF, the second SMF, the AMF, the UDM, the MME, or the ePDG described above may be implemented as or through the apparatus 1000.

The apparatus 1000 comprises at least one processor 1021, such as a digital processor (DP), and at least one memory (MEM) 1022 coupled to the processor 1021. The apparatus 1000 may further comprise a transmitter TX and receiver RX 1023 coupled to the processor 1021. The MEM 1022 stores a program (PROG) 1024. The PROG 1024 may include instructions that, when executed on the associated processor 1021, enable the apparatus 1000 to operate in accordance with the embodiments of the present disclosure. A combination of the at least one processor 1021 and the at least one MEM 1022 may form processing means 1025 adapted to implement various embodiments of the present disclosure.

Various embodiments of the present disclosure may be implemented by computer program executable by one or more of the processor 1021, software, firmware, hardware or in a combination thereof.

The MEM 1022 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1021 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first SMF, the memory 1022 contains instructions executable by the processor 1021, whereby the first PGW-C/SMF operates according to any of the methods related to the first SMF as described above.

In an embodiment where the apparatus is implemented as or at the first PGW-C/SMF, the memory 1022 contains instructions executable by the processor 1021, whereby the first PGW-C/SMF operates according to any of the methods related to the first PGW-C/SMF as described above.

In an embodiment where the apparatus is implemented as or at the second SMF, the memory 1022 contains instructions executable by the processor 1021, whereby the second SMF operates according to any of the methods related to the second SMF as described above.

In an embodiment where the apparatus is implemented as or at the AMF, the memory 1022 contains instructions executable by the processor 1021, whereby the AMF operates according to any of the methods related to the AMF as described above.

In an embodiment where the apparatus is implemented as or at the UDM, the memory 1022 contains instructions executable by the processor 1021, whereby the UDM F operates according to any of the methods related to the UDM as described above.

In an embodiment where the apparatus is implemented as or at the MME, the memory 1022 contains instructions executable by the processor 1021, whereby the MME operates according to any of the methods related to the MME as described above.

In an embodiment where the apparatus is implemented as or at the ePDG, the memory 1022 contains instructions executable by the processor 1021, whereby the ePDG operates according to any of the methods related to the ePDG as described above.

FIG. 11a is a block diagram showing a first SMF according to an embodiment of the disclosure. As shown, the first SMF 1100 comprises a sending module 1101 configured to send alternative packet data network gateway (PGW) control plane (PGW-C)/SMF information to a second SMF or an access and mobility management function (AMF) or a unified data management (UDM).

FIG. 11b is a block diagram showing a first PGW-C/SMF according to an embodiment of the disclosure. As shown, the first PGW-C/SMF 1150 may comprise an establishing module 1151 configured to establish a PDU session for a User Equipment (UE). The first PGW-C/SMF 1150 may further comprise a sending module 1152 configured to send alternative PGW-C/SMF information to a second SMF for the PDU session anchored at the first SMF+PGW-C or an access and mobility management function (AMF). An alternative PGW-C/SMF will be selected based on the alternative PGW-C/SMF information in an event the first PGW-C/SMF has failed.

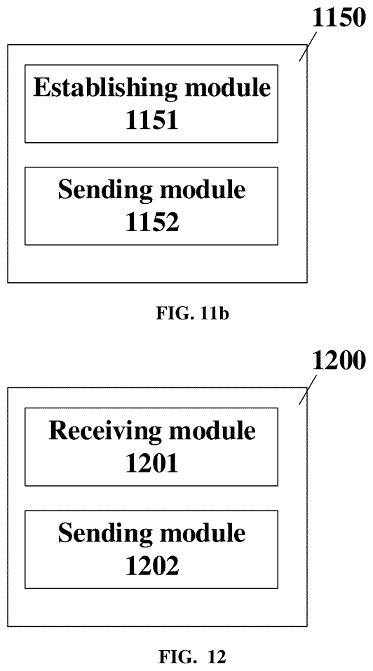

FIG. 12 is a block diagram showing a second SMF according to an embodiment of the disclosure. As shown, the second SMF 1200 comprises a receiving module 1201 configured to receive alternative packet data network gateway (PGW) control plane (PGW-C)/SMF information from a first SMF. The second SMF 1200 comprises a sending module 1202 configured to send the alternative PGW-C/SMF information to an access and mobility management function (AMF).

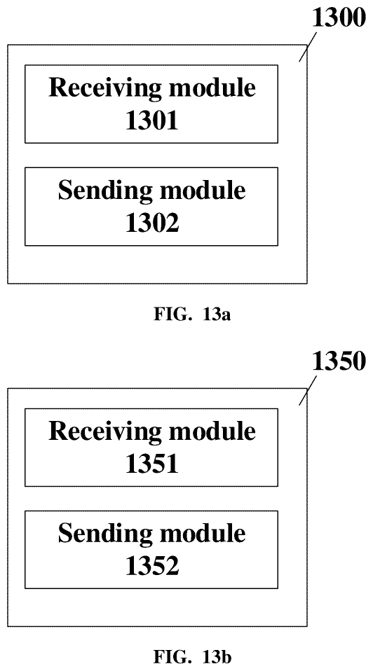

FIG. 13a is a block diagram showing an AMF according to an embodiment of the disclosure. As shown, the AMF 1300 comprises a receiving module 1301 configured to receive alternative packet data network gateway (PGW) control plane (PGW-C)/SMF information from a first session management function (SMF) or a second SMF. The AMF 1300 comprises a sending module 1302 configured to send the alternative PGW-C/SMF information to a mobility management entity (MME).

FIG. 13b is a block diagram showing an AMF in a first telecommunication system according to an embodiment of the disclosure. As shown, the AMF 1350 may comprise a receiving module 1351 configured to receive alternative packet data network gateway control plane/Session Management Function (PGW-C/SMF) information from a first PGW-C/SMF or a second SMF. The AMF 1350 may comprise a sending module 1352 configured to send the alternative PGW-C/SMF information to a mobility management entity (MME) in a second telecommunication system.

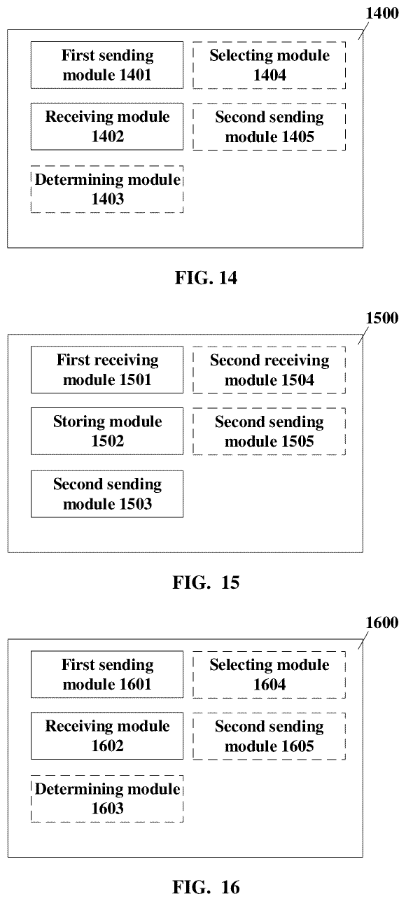

FIG. 14 is a block diagram showing an MME according to an embodiment of the disclosure. As shown, the MME 1400 may comprise a first sending module 1401 configured to send a context request to an access and mobility management function (AMF). The MME 1400 may further comprise a receiving module 1402 configured to receive a context response comprising first PGW-C/SMF information and alternative packet data network gateway (PGW) control plane (PGW-C)/SMF information from the AMF.

In an embodiment, the MME 1400 comprises a determining module 1403 configured to determine that the first SMF is failed.

In an embodiment, the MME 1400 comprises a selecting module 1404 configured to select an alternative PGW-C/SMF based on the alternative PGW-C/SMF information.

In an embodiment, the MME 1400 comprises a second sending module 1405 configured to send a create session request to the alternative PGW-C/SMF.

FIG. 15 is a block diagram showing a UDM according to an embodiment of the disclosure. As shown, the UDM 1500 comprises a first receiving module 1501 configured to receive a registration request comprising first session management function (SMF) information and alternative packet data network gateway (PGW) control plane (PGW-C)/SMF information from a first session management function (SMF). The UDM 1500 comprises a storing module 1502 configured to store the first SMF information and the alternative PGW-C/SMF information. The UDM 1500 comprises a second sending module 1503 configured to send a registration response to the first SMF.

In an embodiment, the UDM 1500 comprises a second receiving module 1504 configured to receive a request for retrieving the address of the first session management function (SMF) and the alternative PGW-C/SMF information from a network node.

In an embodiment, the UDM 1500 comprises a second sending module 1505 configured to sending a response comprising the first SMF information and the alternative PGW-C/SMF information to the network node.

FIG. 16 is a block diagram showing an ePDG according to an embodiment of the disclosure. As shown, the ePDG 1600 comprises a first sending module 1601 configured to send a request for retrieving first session management function (SMF) information and alternative packet data network gateway (PGW) control plane (PGW-C)/SMF information to a unified data management (UDM). The ePDG 1600 comprises a receiving module 1602 configured to receive a response comprising the first SMF information and the alternative PGW-C/SMF information from the UDM.

In an embodiment, the ePDG 1600 comprises a determining module 1603 configured to determine that the first SMF is failed.

In an embodiment, the ePDG 1600 comprises a selecting module 1604 configured to select an alternative PGW-C/SMF based on the alternative PGW-C/SMF information.

In an embodiment, the ePDG 1600 comprises a second sending module 1605 configured to send a create session request to the alternative PGW-C/SMF.

Embodiments herein may provide many advantages, of which a non-exhaustive list of examples follows. In some embodiments herein, it can secure that the PDU session can successfully move from 5G to 4G mobility even when the serving combined PGW-C/SMF has failed (as long as it pertains to a combined PGW-C/SMF set). In some embodiments herein, it can enable the MME or ePDG or AMF to select an alternative PGW-C/SMF based on the alternative PGW-C/SMF information. The embodiments herein are not limited to the features and advantages mentioned above. A person skilled in the art will recognize additional features and advantages upon reading the following detailed description.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first SMF, the second SMF, the AMF, the first PGW-C/SMF, the UDM, the MME, or the ePDG may not need a fixed processor or memory, any computing resource and storage resource may be arranged from the first SMF, the first PGW-C/SMF, the second SMF, the AMF, the UDM, the MME, or the ePDG in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by an access and mobility management function, AMF, in a first telecommunication system, comprising:
receiving alternative packet data network gateway control plane/Session Management Function, PGW-C/SMF, information from a first PGW-C/SMF or a second SMF; and
sending the alternative PGW-C/SMF information to a mobility management entity, MME, in a second telecommunication system.

2. The method according to claim 1, wherein receiving the alternative PGW-C/SMF information from the first PGW-C/SMF or the second SMF comprises:
sending a Protocol Data Unit, PDU, session context request to the first PGW-C/SMF or the second SMF; and
receiving a PDU session context response comprising the alternative PGW-C/SMF information from the first PGW-C/SMF or the second SMF.

3. The method according to claim 1, wherein sending the alternative PGW-C/SMF information to the MME comprises:
receiving a context request from the MME; and
sending a context response comprising the alternative PGW-C/SMF information to the MME.

4. The method according to claim 1, wherein the first PGW-C/SMF is a home PGW-C/SMF or an anchor PGW-C/SMF and/or the second SMF is a visited SMF or an intermediate SMF.

5. The method according to claim 1, wherein the alternative PGW-C/SMF information comprises information of at least one PGW-C/SMF, so that an alternative PGW-C/SMF can be selected; and/or wherein the alternative PGW-C/SMF information is used by the AMF or the MME or an evolved packet data gateway, ePDG, to select an alternative PGW-C/SMF.

6. (canceled)

7. The method according to claim 1, wherein the first PGW-C/SMF and the alternative PGW-C/SMF are functionally equivalent and inter-changeable and share same contexts.

8. A method performed by a first PGW-C/SMF, comprising:
establishing a PDU session for a User Equipment, UE; and
sending alternative PGW-C/SMF information to a second SMF for the PDU session anchored at the first SMF+PGW-C or an access and mobility management function, AMF,
wherein an alternative PGW-C/SMF will be selected based on the alternative PGW-C/SMF information in an event the first PGW-C/SMF has failed.

9. The method according to claim 8, wherein sending the alternative PGW-C/SMF information to the second SMF comprises:
receiving a protocol data unit (PDU) session create request from the second SMF; and
sending a PDU session create response comprising the alternative PGW-C/SMF information to the second SMF.

10. The method according to claim 9, wherein the alternative PGW-C/SMF information is comprised in PDU session created data of the PDU session create response.

11. (canceled)

12. The method according to claim 8, wherein sending the alternative PGW-C/SMF information to the second SMF comprises:
receiving a PDU session update request from the second SMF; and
sending a PDU session update response comprising the alternative PGW-C/SMF information to the second SMF.

13. The method according to claim 12, wherein the alternative PGW-C/SMF information is comprised in home SMF updated data of the PDU session update response.

14. (canceled)

15. The method according to claim 8, wherein sending the alternative PGW-C/SMF information to the second SMF comprises:
sending a PDU session update request comprising the alternative PGW-C/SMF information to the second SMF; and
receiving a PDU session update response from the second SMF.

16. The method according to claim 15, wherein the alternative PGW-C/SMF information is comprised in visited SMF update data of the PDU session update request.

17. The method according to claim 15, wherein the first PGW-C/SMF is a home PGW-C/SMF or an anchor PGW-C/SMF and/or the second SMF is a visited SMF or an intermediate SMF.

18. The method according to claim 8, wherein sending the alternative PGW-C/SMF information to the AMF comprises:
receiving a PDU session context request from the AMF; and
sending a PDU session context response comprising the alternative PGW-C/SMF information to the AMF.

19. The method according to claim 8, wherein the alternative PGW-C/SMF information comprises information of at least one PGW-C/SMF, so that the alternative PGW-C/SMF can be selected.

20. The method according to claim 8, wherein the alternative PGW-C/SMF information is used by the AMF or a mobility management entity, MME, or an evolved packet data gateway, ePDG, to select an alternative PGW-C/SMF.

21. The method according to claim 8, wherein the first PGW-C/SMF and the alternative PGW-C/SMF are functionally equivalent and inter-changeable and share same contexts.

22.-28. (canceled)

29. A first PGW-C/SMF, comprising:
a processor; and
a memory coupled to the processor, said memory containing instructions executable by said processor, whereby the first PGW-C/SMF is operative to:
establish a PDU session for a User Equipment, UE; and
send alternative PGW-C/SMF information to a second SMF for the PDU session anchored at the first SMF+PGW-C or an access and mobility management function, AMF;
wherein an alternative PGW-C/SMF will be selected based on the alternative PGW-C/SMF information in an event the first PGW-C/SMF has failed.

30.-34. (canceled)
